(19) United States
(12) Patent Application Publication
(10) Pub. No.: US 2022/0402574 A1
(43) Pub. Date: Dec. 22, 2022

(54) TRANSMISSION SYSTEM

(71) Applicant: CLASSIFIED CYCLING B.V., Turnhout (BE)

(72) Inventors: Roëll Marie VAN DRUTEN, Eindhoven (NL); Johannes Gijsbertus Antonius VAN DEN BRAND, Eindhoven (NL)

(21) Appl. No.: 17/771,314

(22) PCT Filed: Oct. 23, 2020
(86) PCT No.: PCT/NL2020/050659

§ 371 Date: Apr. 22, 2022

(30) Foreign Application Priority Data
Oct. 25, 2019 (NL) PCT/NL2019/050706

(51) Int. Cl. B62M 11/16; B62M 6/65

(52) U.S. Cl. CPC B62M 11/16; B62M 6/65

(57) ABSTRACT

A transmission system, such as for a two wheeled bicycle, having an input and an output, wherein the input is arranged to be connected to a crank and/or an electric motor and/or a user input, and wherein the output is arranged to be connected to a driven wheel. The system includes at least two parallel transmission paths from the input to the output, at least one of the transmission paths including at least one transmission, at least one of the transmission paths including at least one transmission clutch. At least one of the transmission paths includes at least one load-shifting clutch, the at least one load-shifting clutch being a form closed clutch arranged to transfer torque in at least one rotational direction.

### FIELD OF THE INVENTION

The invention relates to a clutch system for a torque transmission having an input arranged for connection to a drive source, and an output arranged for connection to a load.

### BACKGROUND TO THE INVENTION

Transmission systems for bicycles are known. In bicycles, especially racing bicycles, the transmission system traditionally includes a front derailleur and a rear derailleur, for shifting gears of the transmission system. An alternative to derailleurs is formed by gear hubs, where shifting of gears is accommodated by a gear shifting mechanism inside the, generally rear, wheel hub. A hybrid form is known where a gear hub torque transmission having at least two selectable gear ratios is coupled between the rear wheel hub and the rear sprocket. Herein the rear sprocket can include a plurality of gear wheels, selectable through a rear derailleur. Here the gear hub can take the place of a front derailleur.

Such gear hub gear shifting mechanisms can include one or more planetary gear sets. The planetary gear includes at least three rotational members, such as a sun gear, a planet carrier and a ring gear. A clutch system can be used for selectively coupling two of the rotational members, e.g. the planet carrier and the ring gear. When coupled, the hub gear shifting mechanism operates according to a first gear ratio. When decoupled, the hub gear shifting mechanism operates according to a second gear ratio.

Also gear hub shifting mechanisms are known wherein mechanisms are included in the gear hub for providing a plurality of different transmission ratios, such as five, seven or fourteen different gear ratios.

Many of these systems have in common that up- and downshifting is not always possible, depending on the riders pedal force. In some systems, it is required that the rider stops pedaling, or at least stops providing torque load to the system to allow up-shifting and/or down-shifting.

### SUMMARY OF THE INVENTION

It is an object to provide a transmission system for a two wheeled bicycle. Alternatively, or additionally, it is an object to enable, preferably electronically actuated, shifting of gears, wherein up- and downshifting should always be possible, not depending on the riders pedal force and/or electromotor torque.

According to an aspect is provided a transmission system for a two wheeled bicycle, having an input and an output. The input is arranged to be connected to a crank and/or an electric motor and/or a driver input. The output is arranged to be connected to a driven wheel. The system includes at least two parallel transmission paths from the input to the output. At least one of the transmission paths includes at least one transmission. At least one of the transmission paths including at least one transmission clutch. At least one of the transmission paths includes at least one load-shifting clutch. The at least one load-shifting clutch is a form closed clutch arranged to transfer torque in at least one rotational direction.

According to an aspect the at least one load-shifting clutch is arranged for being be decoupled, and preferably coupled, under load, preferably in two rotational directions. Hence, the at least one load-shifting clutch can be decoupled and/or coupled while the load-shifting clutch is transferring a torque, wherein the decoupling can be effected with low effort. A clutch arranged to couple and decouple under load can be more expensive than a clutch system which cannot couple and decouple under load. Therefore, it can be an advantage to minimize the number of load-shifting clutches.

Optionally, a first transmission path includes a first load-shifting clutch that is arranged for being be decoupled under load, and a second transmission path includes a second load-shifting clutch that is arranged for being be decoupled under load.

Optionally, at least one of the transmission paths contains two or more transmissions. Optionally, at least one of the transmission paths includes at least two transmission elements with which two different transmission ratios can be made. The transmission clutch can be used for selecting either the first transmission ratio or the second transmission ratio. The transmission clutch can be embodied as a one-way bearing, one-way clutch, dog-clutch, spline-clutch. The transmission clutch can be constructed such that it cannot be decoupled under load with low effort.

Optionally, at least one of the transmission clutches is arranged for preselecting of a transmission element by actuation of said transmission clutch, such as through a transmission actuator. Optionally, the system is arranged for preselecting of a transmission element only in the transmission path via which no, or at least limited, torque is transmitted at the moment of actuation. Hence, in the transmission path where no torque, or limited torque, is transmitted the, lower cost, transmission clutches can be shifted under no-load conditions, also referred to as preselection. Once the desired transmission ratio has been preselected using the transmission clutch in the no-load transmission path, the load-shifting clutch can shift the load to this transmission path. As the other transmission path is now rendered in no-load condition, it is possible to preselect a desired transmission ratio in that transmission path.

Optionally, the transmission system includes two transmission paths. Each transmission path includes a load-shifting clutch arranged for decoupling under load. At least one of the transmission paths includes at least two transmission elements with which two different transmission ratios can be made and at least one transmission clutch for preselecting of a transmission element. Optionally both transmission paths each include at least two transmission elements with which two different transmission ratios can be made and at least one transmission clutch for preselecting of a transmission element.

Optionally, at least one of the transmission clutches is actuated with a mechanical, electrical and/or hydraulical actuator. Optionally, the at least one transmission clutch and the at least one load-shifting clutch are arranged for being operated independently. Optionally, actuators for actuation of at least one transmission clutch and the at least one load-shifting clutch are arranged for being operated independently.

Optionally, actuators for actuation of the at least one load-shifting clutch and the at least one transmission clutch are arranged for being operated electronically by an actuator controller. Optionally, the actuator controller is arranged for communicating with an electric motor controller in an electric bicycle and/or is physically integrated with an electric motor controller, e.g. with an electric motor controller printed circuit board.

Optionally, the controller is arranged for adjusting a torque of the electric motor just before, after and/or during a transmission ratio change. Thus, the controller can enable the requested wheel torque demand.

Optionally, the controller is arranged to initiate a transmission ratio change based on a wheel-speed, a crank-speed, a crank-torque, a wheel-torque, and/or other available parameters.

Optionally, the system includes an additional transmission element, such as a reduction, in one of the transmission paths, or between the crank or electric motor and the input, or between the wheel and the output of the transmission system.

According to an aspect is provided a bicycle wheel including the transmission system as described hereinabove.

According to an aspect is provided a bicycle including the transmission system as described hereinabove.

Optionally, the transmission system is located near the bicycle rear wheel and optionally the rear wheel shaft is integrated in the transmission system, or the transmission system is located near the bicycle crank and optionally the crank shaft is integrated in the transmission system.

Optionally, the at least one load-shifting clutch of the transmission system has a clutch input, and a clutch output. The load-shifting clutch includes a first unit connectable to the load-shifting clutch input or load-shifting clutch output, including at least one first abutment surface. The load-shifting clutch includes a second unit connectable to the load-shifting clutch output or load-shifting clutch input, respectively, including at least one second abutment surface arranged for selectively engaging the first abutment surface. The first and second abutment surfaces are adapted to each other so as to allow disengaging under load, preferably in two directions. The load-shifting clutch includes a third unit including at least one retaining member. The third unit is arranged for selectively being in a first mode or a second mode relative to the second unit. The at least one retaining member in the first mode locks the at least one second abutment surface for rotationally coupling the second unit to the first unit, preferably in two directions, and in the second mode releases the at least one second abutment surface for decoupling the second unit from the first unit.

The transmission system including such load-shifting clutch (or clutches) can be manufactured in a small form-factor suitable for integration in a two-wheeled bicycle.

According to an aspect is provided a bicycle wheel axle assembly, such as a rear wheel axle assembly, including a transmission system as described herein. The input of the transmission system arranged to be connected to a crank and/or an electric motor and/or a driver input, can be connected to a driver of the wheel axle assembly. The driver can be configured to driven by a crank, e.g. via chain drive, belt drive or cardan drive. The input can be rigidly connected to, e.g. formed by, the driver. The input can be connected to the driver via a freewheel clutch. The driver can be arranged to attach one or more sprockets thereto, such as a cassette comprising a plurality of sprockets, e.g. for the chain drive. The driver can be arranged to attach a belt pulley thereto, e.g. for the belt drive. The driver can be arranged to attach a (bevel) gear thereto, e.g. for the cardan drive, The output of the transmission system arranged to be connected to a driven wheel, can be connected to a wheel hub of the wheel axle assembly. The output can be rigidly connected to, e.g. formed by, the wheel hub. The output can be connected to the wheel hub via a freewheel clutch. The wheel hub can e.g. include spokes flanges or be otherwise connected to a rim of the driven wheel. The transmission system as described herein can be positioned inside the hub and/or the driver. The at least two parallel transmission paths from the input to the output can be positioned inside the wheel hub and/or the driver. Thus, the at least one transmission, the at least one transmission clutch and the at least one load-shifting clutch can be positioned inside the hub and/or the driver.

Optionally, the electric motor is positioned inside the hub and/or the driver. A stator of the electric motor can be positioned concentrically inside a rotor of the electric motor. The stator can be rigidly connected to an axle of the wheel hub assembly. The axle can be configured to be attached to a frame of the bicycle, such that the axle does not rotate relative to the frame. The axle can be a hollow axle.

Optionally, the driver is connected to an intermediate drive part, e.g. via a freewheel clutch, for driving the intermediate drive part in rotation. The intermediate drive part can form an inner shell, rotatably housed inside the wheel hub. The rotor of the electric motor can be connected to the intermediate drive part, e.g. via a motor transmission, for driving the intermediate drive part in rotation. The motor transmission can directly rigidly couple to the intermediate drive part, or via a freewheel clutch. Alternatively, the rotor can directly rigidly couple to the intermediate drive part, or via a freewheel clutch. The electric motor can be connected to drive the intermediate drive part, which in turn can be connected to drive the transmission system, which in turn can be connected to drive the wheel hub. Alternatively, the electric motor can be connected to drive the wheel hub directly, or via the motor transmission.

Optionally, the intermediate drive part is positioned, at least partially, radially inside the cassette. Optionally, the intermediate drive part is positioned radially inside at least some sprockets of the plurality of sprockets. The cassette can have a tapered central axial opening. The tapered central axial opening can have a larger diameter at larger sprockets and a smaller diameter at smaller sprockets. The sprockets of the plurality of sprockets can each have a central opening, wherein the central opening of larger sprockets is larger than the central opening of smaller sprockets. Optionally, the cassette and driver are configured to transmit torque from the cassette to the driver at portion of the cassette axially away from a largest sprocket of the cassette in a direction of a smallest sprocket of the cassette. Optionally, the cassette and driver are configured to transmit torque from the cassette to the driver at portion of the cassette at or near the smallest sprocket of the cassette. Optionally, the plurality of sprockets and driver are configured to transmit torque from the plurality of sprockets to the driver at portion of the plurality of sprockets axially away from a largest sprocket of the plurality of sprockets in a direction of a smallest sprocket of the plurality of sprockets. Optionally, the plurality of sprockets and driver are configured to transmit torque from the plurality of sprockets to the driver at portion of the plurality of sprockets at or near the smallest sprocket of the plurality of sprockets. Optionally, the cassette transmits torque to the driver on a diameter that is smaller than a diameter of a smallest sprocket of the cassette. Optionally, the cassette transmits torque to the driver on a diameter that is smaller than or equal to an inner diameter of the smallest sprocket of the cassette. Optionally, the driver is configured to transmit torque to the intermediate drive part on a diameter that is smaller than a diameter of a smallest sprocket connected to the driver.

Optionally, the sprocket(s) or cassette which are connected to the driver are supported on the wheel hub directly via a bearing.

Optionally, the wheel hub is supported on the driver side of the wheel axle assembly via a bearing, which bearing is positioned axially further from a center of the wheel axle assembly than a middle sprocket.

The electric motor can be configured, e.g. by a controller, to act as motor for providing assistance during riding. It is also possible that the electric motor is configured, e.g. by a controller, to act as a generator. The electric motor acting as generator can be used for charging a battery of the bicycle. The electric motor acting as generator can also be used for providing additional resistance against rotation to the wheel hub, e.g. for training purposes.

Alternatively, or additionally, it is an object to provide a clutch or brake system, e.g. for a torque transmission, which is cost-effective, can be manufactured with a small size, is easy to operate and/or is durable. Alternatively, or additionally, it is an object to provide a clutch or brake system, e.g. for a torque transmission, which can be operated under load, e.g. while pedaling. Alternatively, or additionally, it is an object to provide a clutch or brake system, e.g. for a torque transmission, which can be operated for coupling and/or for decoupling under load, e.g. while pedaling. Alternatively, or additionally, it is an object to provide a clutch or brake system, e.g. for a torque transmission, which can be operated both for upshifting and for downshifting under load, e.g. while pedaling. More in general it is an object to provide an improved clutch or brake system, e.g. for a torque transmission, or at least an alternative clutch or brake system, e.g. for a torque transmission.

The transmission system as described herein can comprise the torque transmission and the clutch or brake system. The clutch or brake system can form the load-shifting clutch of the transmission system.

According to an aspect is provided a clutch or brake system having an input, and an output. The system includes a first unit connectable to the input or output, and a second unit connectable to the output or input, respectively. The first unit includes at least one first abutment surface. The second unit includes at least one second abutment surface arranged for selectively engaging the first abutment surface. The first and second abutment surfaces are adapted to each other so as to allow disengaging under load. The system includes a third unit. The third unit includes at least one retaining member. The third unit is arranged for selectively being in a first mode or a second mode relative to the second unit. In the first mode the at least one retaining member locks the at least one second abutment surface for rotationally coupling the second unit to the first unit. In the second mode the at least one retaining member releases the at least one second abutment surface for decoupling the second unit from the first unit.

Such clutch or brake system can be advantageously used in the transmission system as described hereinabove.

According to an aspect at least one of the first unit, the second unit, and the third unit is rotatable. Optionally, at least two of the first unit, the second unit, and the third unit are rotatable. Optionally, all of the first unit, the second unit, and the third unit are rotatable.

According to an aspect the first unit or the second unit is non-rotatable. The non-rotatable first unit or second unit can be used for braking a rotatable second unit or first unit, respectively. Optionally, two of the first unit, the second unit, and the third unit are non-rotatable.

According to an aspect, it applies for the clutch or brake system that:

a) the first unit is connectable to the input, the second unit is connectable to the output, the second unit is arranged at least partially coaxially inside the first unit, and the third unit is arranged at least partially coaxially inside the second unit;
b) the first unit is connectable to the output, the second unit is connectable to the input, the second unit is arranged at least partially coaxially inside the first unit, and the third unit is arranged at least partially coaxially inside the second unit;
c) the first unit is connectable to the output, the second unit is connectable to the input, the first unit is arranged at least partially coaxially inside the second unit, and the second unit is arranged at least partially coaxially inside the third unit;
d) the first unit is connectable to the input, the second unit is connectable to the output, the first unit is arranged at least partially coaxially inside the second unit, and the second unit is arranged at least partially coaxially inside the third unit;
e) the first unit is connectable to the input, the second unit is connectable to the output, the second unit is arranged at least partially axially beside the first unit, and the third unit is arranged at least partially axially beside the first unit or the second unit;
f) the first unit is connectable to the output, the second unit is connectable to the input, the second unit is arranged at least partially axially beside the first unit, and the third unit is arranged at least partially axially beside the first unit or the second unit;
g) the first unit is connectable to the input, the second unit is connectable to the output, the second unit is arranged at least partially coaxially inside the first unit, and the third unit is arranged at least partially axially beside the first and/or second unit;
h) the first unit is connectable to the output, the second unit is connectable to the input, the second unit is arranged at least partially coaxially inside the first unit, and the third unit is arranged at least partially axially beside the first and/or second unit;
i) the first unit is connectable to the input, the second unit is connectable to the output, the first unit is arranged at least partially coaxially inside the second unit, and the third unit is arranged at least partially axially beside the first and/or second unit;
j) the first unit is connectable to the output, the second unit is connectable to the input, the first unit is arranged at least partially coaxially inside the second unit, and the third unit is arranged at least partially axially beside the first and/or second unit;
k) the first unit is connectable to the input, the second unit is connectable to the output, the second unit is arranged at least partially axially beside the first unit, and the third unit is arranged at least partially coaxially inside the first and/or second unit;
l) the first unit is connectable to the input, the second unit is connectable to the output, the second unit is arranged at least partially axially beside the first unit, and the third unit is arranged at least partially coaxially inside the first and/or second unit;
m) the first unit is connectable to the input, the second unit is connectable to the output, the second unit is arranged at least partially axially beside the first unit, and the third unit is arranged at least partially coaxially around the first and/or second unit; or
n) the first unit is connectable to the input, the second unit is connectable to the output, the second unit is arranged at least partially axially beside the first unit, and the third unit is arranged at least partially coaxially around the first and/or second unit.

According to an aspect, the clutch or brake system includes a fourth unit arranged for actuating, such as rotating, the third unit from the first mode to the second mode, and/or from the second mode to the first mode. Optionally, the fourth unit is non-rotatable.

According to an aspect it applies for the clutch or brake system that:

a) the first unit is connectable to the input, the second unit is connectable to the output, the second unit is arranged at least partially coaxially inside the first unit, the third unit is arranged at least partially coaxially inside the second unit, and the fourth unit is arranged at least partially coaxially inside the third unit;
b) the first unit is connectable to the output, the second unit is connectable to the input, the second unit is arranged at least partially coaxially inside the first unit, the third unit is arranged at least partially coaxially inside the second unit, and the fourth unit is arranged at least partially coaxially inside the third unit;
c) the first unit is connectable to the output, the second unit is connectable to the input, the first unit is arranged at least partially coaxially inside the second unit, the second unit is arranged at least partially coaxially inside the third unit, and the third unit is arranged at least partially coaxially inside the fourth unit;
d) the first unit is connectable to the input, the second unit is connectable to the output, the first unit is arranged at least partially coaxially inside the second unit, the second unit is arranged at least partially coaxially inside the third unit, and the third unit is arranged at least partially coaxially inside the fourth unit;
e) the first unit is connectable to the input, the second unit is connectable to the output, the second unit is arranged at least partially axially beside the first unit, the third unit is arranged at least partially axially beside the first unit or the second unit, and the fourth unit is arranged at least partially axially beside the third unit;
f) the first unit is connectable to the output, the second unit is connectable to the input, the second unit is arranged at least partially axially beside the first unit, the third unit is arranged at least partially axially beside the first unit or the second unit, and the fourth unit is arranged at least partially axially beside the third unit;
g) the first unit is connectable to the input, the second unit is connectable to the output, the second unit is arranged at least partially coaxially inside the first unit, the third unit is arranged at least partially axially beside the first and/or second unit and the fourth unit is arranged at least partially axially beside the third unit;
h) the first unit is connectable to the output, the second unit is connectable to the input, the second unit is arranged at least partially coaxially inside the first unit, the third unit is arranged at least partially axially beside the first and/or second unit, and the fourth unit is arranged at least partially axially beside the third unit;
i) the first unit is connectable to the input, the second unit is connectable to the output, the second unit is arranged at least partially coaxially inside the first unit, the third unit is arranged at least partially axially beside the first and/or second unit and the fourth unit is arranged at least partially coaxially inside and/or outside the third unit;
j) the first unit is connectable to the output, the second unit is connectable to the input, the second unit is arranged at least partially coaxially inside the first unit, the third unit is arranged at least partially axially beside the first and/or second unit, and the fourth unit is arranged at least partially coaxially inside and/or outside the third unit;
k) the first unit is connectable to the input, the second unit is connectable to the output, the first unit is arranged at least partially coaxially inside the second unit, the third unit is arranged at least partially axially beside the first and/or second unit, and the fourth unit is arranged at least partially axially beside the third unit;
l) the first unit is connectable to the output, the second unit is connectable to the input, the first unit is arranged at least partially coaxially inside the second unit, the third unit is arranged at least partially axially beside the first and/or second unit, and the fourth unit is arranged at least partially axially beside the third unit;
m) the first unit is connectable to the input, the second unit is connectable to the output, the first unit is arranged at least partially coaxially inside the second unit, the third unit is arranged at least partially axially beside the first and/or second unit, and the fourth unit is arranged at least partially coaxially inside and/or outside the third unit;
n) the first unit is connectable to the output, the second unit is connectable to the input, the first unit is arranged at least partially coaxially inside the second unit, the third unit is arranged at least partially axially beside the first and/or second unit, and the fourth unit is arranged at least partially coaxially inside and/or outside the third unit;
o) the first unit is connectable to the input, the second unit is connectable to the output, the second unit is arranged at least partially axially beside the first unit, the third unit is arranged at least partially coaxially inside the first and/or second unit, and the fourth unit is arranged at least partially coaxially inside the third unit;
p) the first unit is connectable to the input, the second unit is connectable to the output, the second unit is arranged at least partially axially beside the first unit, the third unit is arranged at least partially coaxially inside the first and/or second unit, and the fourth unit is arranged at least partially coaxially inside the third unit;
q) the first unit is connectable to the input, the second unit is connectable to the output, the second unit is arranged at least partially axially beside the first unit, the third unit is arranged at least partially coaxially inside the first and/or second unit, and the fourth unit is arranged at least partially axially beside the third unit;
r) the first unit is connectable to the input, the second unit is connectable to the output, the second unit is arranged at least partially axially beside the first unit, the third unit is arranged at least partially coaxially inside the first and/or second unit, and the fourth unit is arranged at least partially axially beside the third unit;
s) the first unit is connectable to the input, the second unit is connectable to the output, the second unit is arranged at least partially axially beside the first unit, the third unit is arranged at least partially coaxially around the first and/or second unit, and the fourth unit is arranged at least partially coaxially around the third unit;
t) the first unit is connectable to the input, the second unit is connectable to the output, the second unit is arranged at least partially axially beside the first unit, the third unit is arranged at least partially coaxially around the first and/or second unit, and the fourth unit is arranged at least partially coaxially around the third unit;
u) the first unit is connectable to the input, the second unit is connectable to the output, the second unit is arranged at least partially axially beside the first unit, the third unit is arranged at least partially coaxially around the first and/or second unit, and the fourth unit is arranged at least partially axially beside the third unit; or
v) the first unit is connectable to the input, the second unit is connectable to the output, the second unit is arranged at least partially axially beside the first unit, the third unit is arranged at least partially coaxially around the first and/or second unit, and the fourth unit is arranged at least partially axially beside the third unit.

According to an aspect is provided a clutch or brake system, such as for a torque transmission. Such clutch or brake system can be used in a vehicle, such as a bicycle or car, a windmill, or the like. The clutch or brake system has an input, e.g. arranged for connection to a drive source, and an output, e.g. arranged for connection to a load. Preferably, the clutch system is operable under load between the input and the output. More preferably, the clutch system is operable under load between the input and the output both when coupling and when decoupling. Preferably, the clutch system is operable under load between the input and the output both during upshift and downshift of the torque transmission. The clutch system includes a first, e.g. rotatable, unit, e.g. a housing, connectable to the input or the output. The clutch system includes a second, e.g. rotatable, unit connectable to the output or input, respectively. The first unit includes at least one first abutment surface. The second unit includes at least one second abutment surface arranged for selectively engaging the first abutment surface. The first and second abutment surfaces are adapted to each other so as to allow disengaging under load, e.g. so as to disengage under load. The clutch or brake system includes a third, e.g. rotatable, unit. The third unit can be arranged for co-rotating with the second unit. The third unit includes at least one retaining member. The third unit is arranged for selectively being in a first mode, such as a first position, or a second mode, such as a second position, relative to the second unit. It will be appreciated that the first position can be a first rotational and/or axial position, and the second position can be a second, different, rotational and/or axial position. The at least one retaining member in the first mode locks the at least one second abutment surface in engagement with the at least one first abutment surface for rotationally coupling the second unit to the first unit. The at least one retaining member in the second mode releases the at least one second abutment surface for disengagement of the at least one first abutment surface for decoupling the second unit from the first unit.

Hence, while the first and second abutment surfaces are adapted to each other so as to allow disengaging under load, or to disengage under load, the relative arrangement, e.g. positioning, of the second and third rotatable units can in the first mode lock the at least one second abutment surface in engagement with the at least one first abutment surface, and in the second mode release the at least one second abutment surface for disengagement of the at least one first abutment surface. Hence, in the first mode, the second unit can be rotationally coupled to the first unit, and in the second mode the second unit can be decoupled from the first unit. Thus a simple and efficient clutch or brake system can be provided.

Optionally, the third unit is arranged for co-rotating with the second unit, and the system is arranged for temporarily changing rotation speed of the third unit relative to the second unit, e.g. by temporarily speeding up, braking or halting the second and/or third unit, for rotating from the first position to the second position, or from the second position to the first position.

Optionally, the clutch system includes an actuator for rotating the third unit and/or the second unit from the first position to the second position, and/or from the second position to the first position. The actuator can be triggerable from outside the clutch system, such as via a control unit. The actuator can e.g. be triggered by external means. The actuator can e.g. be triggered by electrical means or mechanical means. The actuator can e.g. be triggered by manual means such as a user operated button or lever. The actuator can e.g. be triggered by automatic means, such as a controller. The clutch system can include input means. The input means can be arranged for receiving a trigger for triggering the actuator. Triggering of the actuator can be independent of internal forces, torques and/or rotational speeds in the clutch system. Hence, the clutch system can be operated under control of a user or user device.

Optionally, the clutch system includes an actuator for rotating the third unit and/or the second unit from the first position to the second position, and/or from the second position to the first position.

According to an aspect, it applies for the clutch or brake system that:

a) the first unit is connectable to the input, the second unit is connectable to the output, the second unit is arranged at least partially coaxially inside the first unit, and the third unit is arranged at least partially coaxially inside the second unit;
b) the first unit is connectable to the output, the second unit is connectable to the input, the second unit is arranged at least partially coaxially inside the first unit, and the third unit is arranged at least partially coaxially inside the second unit;
c) the first unit is connectable to the output, the second unit is connectable to the input, the first unit is arranged at least partially coaxially inside the second unit, and the second unit is arranged at least partially coaxially inside the third unit;
d) the first unit is connectable to the input, the second unit is connectable to the output, the first unit is arranged at least partially coaxially inside the second unit, and the second unit is arranged at least partially coaxially inside the third unit;
e) the first unit is connectable to the input, the second unit is connectable to the output, the second unit is arranged at least partially axially beside the first unit, and the third unit is arranged at least partially axially beside the first unit or the second unit;
f) the first unit is connectable to the output, the second unit is connectable to the input, the second unit is arranged at least partially axially beside the first unit, and the third unit is arranged at least partially axially beside the first unit or the second unit;
g) the first unit is connectable to the input, the second unit is connectable to the output, the second unit is arranged at least partially coaxially inside the first unit, and the third unit is arranged at least partially axially beside the first and/or second unit;
h) the first unit is connectable to the output, the second unit is connectable to the input, the second unit is arranged at least partially coaxially inside the first unit, and the third unit is arranged at least partially axially beside the first and/or second unit;
i) the first unit is connectable to the input, the second unit is connectable to the output, the first unit is arranged at least partially coaxially inside the second unit, and the third unit is arranged at least partially axially beside the first and/or second unit;
j) the first unit is connectable to the output, the second unit is connectable to the input, the first unit is arranged at least partially coaxially inside the second unit, and the third unit is arranged at least partially axially beside the first and/or second unit;
k) the first unit is connectable to the input, the second unit is connectable to the output, the second unit is arranged at least partially axially beside the first unit, and the third unit is arranged at least partially coaxially inside the first and/or second unit;
l) the first unit is connectable to the input, the second unit is connectable to the output, the second unit is arranged at least partially axially beside the first unit, and the third unit is arranged at least partially coaxially inside the first and/or second unit;
m) the first unit is connectable to the input, the second unit is connectable to the output, the second unit is arranged at least partially axially beside the first unit, and the third unit is arranged at least partially coaxially around the first and/or second unit; or
n) the first unit is connectable to the input, the second unit is connectable to the output, the second unit is arranged at least partially axially beside the first unit, and the third unit is arranged at least partially coaxially around the first and/or second unit.

According to an aspect is provided a clutch or brake system, such as for a torque transmission. Such clutch or brake system can be used in a vehicle, such as a bicycle or car, a windmill, or the like. The clutch or brake system has an input, e.g. arranged for connection to a drive source, and an output, e.g. arranged for connection to a load. Preferably, the clutch or brake system is operable under load between the input and the output. More preferably, the clutch or brake system is operable under load between the input and the output both when coupling and when decoupling. Preferably, the clutch or brake system is operable under load between the input and the output both during upshift and downshift of the torque transmission. The clutch or brake system includes a first, e.g. rotatable, unit, e.g. a housing, connectable to the input or output. The clutch system includes a second, e.g. rotatable, unit connectable to the output or input, respectively. The clutch or brake system includes a third, e.g. rotatable, unit arranged for co-rotating with the second unit. The third unit is arranged for selectively being in a first mode, e.g. rotational position, or a second mode, e.g. rotational position, relative to the second unit. The system is arranged for selectively in the first mode rotationally coupling the second unit to the first unit, and in the second mode decoupling the second unit from the first unit. The system is arranged for temporarily changing rotation speed of the third unit relative to the second unit, e.g. by temporarily speeding up, braking or halting the second and/or third unit, for going, e.g. rotating, from the first mode to the second mode, or from the second mode to the first mode. Hence, the second and third units can in a simple manner be brought from the first mode to the second mode or vice versa.

Optionally, the first unit includes at least one first abutment surface, and the second unit includes at least one second abutment surface arranged for selectively engaging the first abutment surface. The third unit in the first mode, e.g. position, locks the at least one second abutment surface in engagement with the at least one first abutment surface for rotationally coupling the second unit to the first unit, and in the second mode, e.g. position, releases the at least one second abutment surface for disengagement of the at least one first abutment surface for decoupling the second unit from the first unit.

Optionally, the third unit is rotatable relative to the second unit. Optionally a rotation angle of the third unit relative to the second unit is more than 360 degrees. Optionally a rotation angle of the third unit relative to the second unit is unlimited. The clutch or brake system can be free from stop means limiting the rotation angle of the third e unit relative to the second unit.

Optionally, the third unit is arranged to be rotated relative to the second unit from the first position to the second position, and from the second position to the first position in one and the same rotational direction. The third unit can be rotated relative to the second unit in a continued forward rotation for being moved from the first position to the second position, and from the second position to the first position. The third unit can be rotated relative to the second unit in a continued rearward rotation for being moved from the first position to the second position, and from the second position to the first position.

Optionally, the third unit is arranged for selectively being in one of a plurality of first or second positions relative to the second unit. The third unit in each of the first positions of the plurality of first positions locks the at least one second abutment surface in engagement with the at least one first abutment surface for rotationally coupling the second unit to the first unit. The third unit in each of the second positions of the plurality of second positions releases the at least one second abutment surface for disengagement of the at least one first abutment surface for decoupling the second unit from the first unit. The third unit can be arranged to be rotated relative to the second unit from a first first position to a first second position, and from the first second position to a second first position in one and the same rotational direction. The third unit can be arranged to be rotated relative to the second unit from the second first position to a second second position, and from the second second position to a third first position (or to a third first position) in the same one and the same rotational direction. The first positions of the plurality of first positions can e.g. be equally spaced around the perimeter of the second unit. The second positions of the plurality of second positions can e.g. be equally spaced around the perimeter of the second unit. The first positions and second positions can be alternatingly and preferably equally spaced around the perimeter of the second unit. For example, three first positions and three second positions are alternatingly spaced at 60 degrees around the perimeter of the second unit.

Optionally, the second and third units are free from biasing force relative to each other, such that the third unit is not forced into a first or second position relative to the second unit by a force, such as a spring force.

Optionally, the engagement or disengagement of the second abutment surface with the at least one first abutment surface is independent of input torque and/or rotation speed, but relies only on the second and third units being in the first or second relative positions.

Optionally, the at least one second abutment surface of the second rotatable unit is hingedly connected to the remainder of the second unit. Optionally, the at least one second abutment surface of the second unit is hingedly connected to the remainder of the second unit so as to have a single pivot axis.

Optionally, the third unit includes at least one, e.g. as at least two, actuation member arranged for moving the third unit from a first position (e.g. the first position or a first position of the plurality of first positions) to a second position (e.g. the second position or a second position of the plurality of second positions) or from a second position (e.g. the second position or a second position of the plurality of second positions) to a first position (e.g. the first position or a first position of the plurality of first positions) relative to the second unit.

Optionally, the clutch system further includes a, e.g. non-rotatable, fourth unit. The fourth unit includes a selector. The selector is arranged for selectively being in a gripping or non-gripping mode. The selector in the gripping mode is arranged for gripping the at least one actuation member for rotating the third unit from a first position (e.g. the first position or a first position of the plurality of first positions) to a second position (e.g. the second position or a second position of the plurality of second positions) or from a second position (e.g. the second position or a second position of the plurality of second positions) to a first position (e.g. the first position or a first position of the plurality of first positions) relative to the second unit. The selector in the non-gripping mode is arranged for not engaging the at least one actuation member. The selector in the non-gripping mode can allow the third unit to freely rotate with the second unit.

According to an aspect is provided a clutch or brake system, such as for a torque transmission. Such clutch or brake system can be used in a vehicle, such as a bicycle or car, a windmill, or the like. The clutch or brake system has an input, e.g. arranged for connection to a drive source, and an output, e.g. arranged for connection to a load. Preferably, the clutch or brake system is operable under load between the input and the output. More preferably, the clutch or brake system is operable under load between the input and the output both when coupling and when decoupling. Preferably, the clutch or brake system is operable under load between the input and the output both during upshift and downshift of the torque transmission. The clutch or brake system includes a first, e.g. rotatable, unit, e.g. a housing, connectable to the input or output. The clutch or brake system includes a second, e.g. rotatable, unit connectable to the output or input, respectively. The clutch or brake system includes a third, e.g. rotatable, unit arranged for co-rotating with the second unit. The third unit is arranged for selectively being in a first mode, e.g. rotational position, or a second mode, e.g. rotational position, relative to the second unit. The system is arranged for selectively in the first mode rotationally coupling the second unit to the first unit, and in the second mode decoupling the second unit from the first unit. The third unit includes at least one, e.g. as at least two, actuation member arranged for bringing, e.g. moving, the third unit from a mode (e.g. the first position or a first position of a plurality of first positions) to a second mode (e.g. the second position or a second position of a plurality of second positions) or from a second mode (e.g. the second position or a second position of the plurality of second positions) to a first mode (e.g. the first position or a first position of the plurality of first positions) relative to the second unit. The clutch or brake system includes a, e.g. non-rotatable, fourth unit. The fourth unit includes a selector. The selector is arranged for selectively being in a gripping or non-gripping mode. The selector in the gripping mode is arranged for gripping the at least one actuation member for rotating the third unit from a first position (e.g. the first position or a first position of the plurality of first positions) to a second position (e.g. the second position or a second position of the plurality of second positions) or from a second position (e.g. the second position or a second position of the plurality of second positions) to a first position (e.g. the first position or a first position of the plurality of first positions) relative to the second unit. The selector in the non-gripping mode is arranged for not engaging the at least one actuation member. The selector in the non-gripping mode can allow the third unit to freely rotate with the second unit.

Optionally, the first unit includes at least one first abutment surface, and the second unit includes at least one second abutment surface arranged for selectively engaging the first abutment surface. The third unit includes at least one retaining member arranged for in a first position locking the at least one second abutment surface in engagement with the at least one first abutment surface for rotationally coupling the second unit to the first unit, and in a second position releasing the at least one second abutment surface for disengagement of the at least one first abutment surface for decoupling the second unit from the first unit. Optionally, the actuation member is biased into contact with the selector, e.g. by spring force.

Optionally, the third unit includes a first body and a second body, wherein the first body includes the at least one retaining member, and the second body includes the at least one actuation member. Optionally, the third unit includes at least two actuation members, and the second body includes at least one of the actuation members, e.g. all of the actuation members.

Optionally, the first body is rotationally resiliently coupled to the second body, e.g. by means of a spring.

Optionally, the second rotatable unit includes a retractor member arranged for moving the at least one actuation member out of engagement with the selector.

Optionally, the selector includes a groove including a first partial groove and a second partial groove. In gripping mode the partial grooves allow, e.g. align for, engaging the at least one actuation member. In non-gripping mode the partial grooves allow, e.g. are out of alignment for, preventing engagement of the at least one actuation member.

Optionally, the third rotatable body includes two actuation members, optionally arranged such that when the first actuation member is biased into contact with the selector, the second actuation member is maintained at a distance from, e.g. non-engaged by, the selector and vice versa. Optionally, the selector is arranged to be in a first mode or in a second mode. In the first mode the selector is in gripping mode for the first actuation member and in non-gripping mode for the second actuation member. In the second mode the selector is in non-gripping mode for the first actuation member and in gripping mode for the second actuation member.

Optionally, the selector includes a groove including a first partial groove, a second partial groove and a third partial groove. In the first mode the first and second partial grooves allow, e.g. align for, gripping the first actuation member and optionally for not engaging the second actuation member, and in the second mode the second and third grooves allow, e.g. align for, gripping the second actuation member and optionally for not engaging the first actuation member.

Optionally, the first partial groove, the second partial groove and the third partial groove extend on a cylindrical surface of the fourth unit in a direction substantially parallel to an axis of the cylindrical surface.

Optionally, the second partial groove and the third partial groove are arranged to be moved, e.g. relative to the first partial groove, e.g. displaced tangentially. Optionally, the second and third partial groove are arranged to be moved, e.g. simultaneously, in opposite directions.

Optionally, the second partial groove is arranged for moving in the same direction as the first actuation member when the second partial groove moves from the non-gripping mode to the gripping mode for the first actuation member, and the third partial groove is arranged for moving in the same direction as the second actuation member when the third partial groove moves from the non-gripping mode to the gripping mode for the second actuation member. Hence, forces on the selector are minimized, and symmetrical for both actuation members.

Optionally, the at least one second abutment surface is a gripping member arranged for radially moving, e.g. pivoting, in and out of engagement with the at least one first abutment surface.

Optionally, the at least one actuation member is arranged for radially moving, e.g. pivoting, in and out of engagement with the fourth unit.

Optionally, the first and/or second abutment surface is biased to disengage. Hence the default for the first and second abutment surfaces is a disengaged mode. The relative position of the third and second rotatable units then determined whether or not the first and second abutment surfaces are engaged or disengaged.

Optionally, the clutch or brake system includes a plurality of first and/or second abutment surfaces, e.g. distributed along a perimeter of the first and/or second units, respectively. Optionally, the first and/or second abutment surfaces are distributed substantially uniformly along the perimeter of the first and/or second units, respectively. Optionally the number of first abutment surfaces is equal to the number of second abutment surfaces.

Optionally, the clutch or brake system includes a plurality of retaining members.

Optionally, the first, second, third, and/or fourth unit are coaxial. Optionally, the fourth unit is positioned at least partially within the third unit, and/or the third unit is at least partially positioned within the second unit, and/or the second unit is at least partially positioned within the first unit.

Optionally, it applies for the clutch or brake system that:

a) the first unit is connectable to the input, the second unit is connectable to the output, the second unit is arranged at least partially coaxially inside the first unit, the third unit is arranged at least partially coaxially inside the second unit, and the fourth unit is arranged at least partially coaxially inside the third unit;
b) the first unit is connectable to the output, the second unit is connectable to the input, the second unit is arranged at least partially coaxially inside the first unit, the third unit is arranged at least partially coaxially inside the second unit, and the fourth unit is arranged at least partially coaxially inside the third unit;
c) the first unit is connectable to the output, the second unit is connectable to the input, the first unit is arranged at least partially coaxially inside the second unit, the second unit is arranged at least partially coaxially inside the third unit, and the third unit is arranged at least partially coaxially inside the fourth unit;
d) the first unit is connectable to the input, the second unit is connectable to the output, the first unit is arranged at least partially coaxially inside the second unit, the second unit is arranged at least partially coaxially inside the third unit, and the third unit is arranged at least partially coaxially inside the fourth unit;
e) the first unit is connectable to the input, the second unit is connectable to the output, the second unit is arranged at least partially axially beside the first unit, the third unit is arranged at least partially axially beside the first unit or the second unit, and the fourth unit is arranged at least partially axially beside the third unit;
f) the first unit is connectable to the output, the second unit is connectable to the input, the second unit is arranged at least partially axially beside the first unit, the third unit is arranged at least partially axially beside the first unit or the second unit, and the fourth unit is arranged at least partially axially beside the third unit;
g) the first unit is connectable to the input, the second unit is connectable to the output, the second unit is arranged at least partially coaxially inside the first unit, the third unit is arranged at least partially axially beside the first and/or second unit and the fourth unit is arranged at least partially axially beside the third unit;
h) the first unit is connectable to the output, the second unit is connectable to the input, the second unit is arranged at least partially coaxially inside the first unit, the third unit is arranged at least partially axially beside the first and/or second unit, and the fourth unit is arranged at least partially axially beside the third unit;
i) the first unit is connectable to the input, the second unit is connectable to the output, the second unit is arranged at least partially coaxially inside the first unit, the third unit is arranged at least partially axially beside the first and/or second unit and the fourth unit is arranged at least partially coaxially inside and/or outside the third unit;
j) the first unit is connectable to the output, the second unit is connectable to the input, the second unit is arranged at least partially coaxially inside the first unit, the third unit is arranged at least partially axially beside the first and/or second unit, and the fourth unit is arranged at least partially coaxially inside and/or outside the third unit;
k) the first unit is connectable to the input, the second unit is connectable to the output, the first unit is arranged at least partially coaxially inside the second unit, the third unit is arranged at least partially axially beside the first and/or second unit, and the fourth unit is arranged at least partially axially beside the third unit;
l) the first unit is connectable to the output, the second unit is connectable to the input, the first unit is arranged at least partially coaxially inside the second unit, the third unit is arranged at least partially axially beside the first and/or second unit, and the fourth unit is arranged at least partially axially beside the third unit;
m) the first unit is connectable to the input, the second unit is connectable to the output, the first unit is arranged at least partially coaxially inside the second unit, the third unit is arranged at least partially axially beside the first and/or second unit, and the fourth unit is arranged at least partially coaxially inside and/or outside the third unit;
n) the first unit is connectable to the output, the second unit is connectable to the input, the first unit is arranged at least partially coaxially inside the second unit, the third unit is arranged at least partially axially beside the first and/or second unit, and the fourth unit is arranged at least partially coaxially inside and/or outside the third unit;
o) the first unit is connectable to the input, the second unit is connectable to the output, the second unit is arranged at least partially axially beside the first unit, the third unit is arranged at least partially coaxially inside the first and/or second unit, and the fourth unit is arranged at least partially coaxially inside the third unit;
p) the first unit is connectable to the input, the second unit is connectable to the output, the second unit is arranged at least partially axially beside the first unit, the third unit is arranged at least partially coaxially inside the first and/or second unit, and the fourth unit is arranged at least partially coaxially inside the third unit;
q) the first unit is connectable to the input, the second unit is connectable to the output, the second unit is arranged at least partially axially beside the first unit, the third unit is arranged at least partially coaxially inside the first and/or second unit, and the fourth unit is arranged at least partially axially beside the third unit;
r) the first unit is connectable to the input, the second unit is connectable to the output, the second unit is arranged at least partially axially beside the first unit, the third unit is arranged at least partially coaxially inside the first and/or second unit, and the fourth unit is arranged at least partially axially beside the third unit;
s) the first unit is connectable to the input, the second unit is connectable to the output, the second unit is arranged at least partially axially beside the first unit, the third unit is arranged at least partially coaxially around the first and/or second unit, and the fourth unit is arranged at least partially coaxially around the third unit;
t) the first unit is connectable to the input, the second unit is connectable to the output, the second unit is arranged at least partially axially beside the first unit, the third unit is arranged at least partially coaxially around the first and/or second unit, and the fourth unit is arranged at least partially coaxially around the third unit;
u) the first unit is connectable to the input, the second unit is connectable to the output, the second unit is arranged at least partially axially beside the first unit, the third unit is arranged at least partially coaxially around the first and/or second unit, and the fourth unit is arranged at least partially axially beside the third unit; or
v) the first unit is connectable to the input, the second unit is connectable to the output, the second unit is arranged at least partially axially beside the first unit, the third unit is arranged at least partially coaxially around the first and/or second unit, and the fourth unit is arranged at least partially axially beside the third unit.

According to an aspect is provided a torque transmission, including a clutch or brake system as described herein and a planetary gear. The clutch or brake system can be arranged in the torque transmission so as to selectively couple two of the sun gear, the planet carrier and the ring gear of the planetary gear. Optionally, The clutch or brake system is arranged in the torque transmission so as to selectively couple the planet carrier and the ring gear.

According to an aspect is provided a wheel axle assembly, such as a bicycle wheel axle assembly, including the torque transmission. The wheel axle assembly can be arranged for receiving a cassette having a plurality of gear wheels.

According to an aspect is provided a bicycle wheel hub assembly including a clutch or brake system as described herein. The bicycle wheel hub assembly can include a torque transmission, as described. The bicycle wheel hub assembly can include a wheel hub. The clutch or brake system as described herein can be positioned inside the wheel hub. The torque transmission as described herein can be positioned inside the wheel hub. Optionally, the wheel hub is arranged for receiving a cassette having a plurality of gear wheels.

According to an aspect is provided a bicycle including a clutch or brake system as described herein. The bicycle can include a torque transmission, including a clutch or brake system as described herein and a planetary gear. The clutch or brake system can be arranged in the torque transmission so as to selectively couple two of the sun gear, the planet carrier and the ring gear. Optionally, The clutch or brake system is arranged in the torque transmission so as to selectively couple the planet carrier and the ring gear. Optionally, the torque transmission is included in a rear wheel hub of the bicycle. Optionally, a rear cassette having a plurality of gear wheels is attached to the rear wheel hub. The bicycle can include a rear derailleur for selecting one of the plurality of gear wheels of the rear pinion. Optionally, the bicycle includes one single front pinion. In such case, the torque transmission can emulate functioning of a front derailleur.

According to an aspect is provided a method for operating a clutch or brake system for a torque transmission. Such method can be practiced in a vehicle, such as a bicycle or car, a windmill or the like. The clutch system has an input, e.g. arranged for connection to a drive source, and an output, e.g. arranged for connection to a load. Preferably, the clutch or brake system is operable under load between the input and the output. More preferably, the clutch or brake system is operable under load between the input and the output both when coupling and when decoupling. Preferably, the clutch or brake system is operable under load between the input and the output both during upshift and downshift of the torque transmission. The method includes providing a clutch or brake system. The clutch or brake system includes a first, e.g. rotatable, unit, e.g. a housing, connectable to the input or the output. The clutch or brake system includes a second, e.g. rotatable, unit connectable to the output or the input. It is also possible that the first unit is connectable to the output and the second unit is connectable to the input. The first unit includes at least one first abutment surface. The second unit includes at least one second abutment surface arranged for selectively engaging the first abutment surface. The first and second abutment surfaces are adapted to each other so as to allow disengaging under load, e.g. so as to disengage under load. The clutch system includes a third, e.g. rotatable, unit. The third unit can be arranged for co-rotating with the second unit. The third unit includes at least one retaining member. The third unit is arranged for selectively being in a first mode, e.g. a first position, or a second mode, e.g. a second position, relative to the second unit. It will be appreciated that the first position can be a first rotational and/or axial position, and the second position can be a second, different, rotational and/or axial position. The third unit in the first mode locks the at least one second abutment surface in engagement with the at least one first abutment surface for rotationally coupling the second unit to the first unit. The third unit in the second mode releases the at least one second abutment surface for disengagement of the at least one first abutment surface for decoupling the second unit from the first unit. The method includes bringing, e.g. rotating, the third unit relative to the second unit from a first mode to a second mode for disengaging the clutch or brake system, and bringing, e.g. rotating, the third unit relative to the second unit from a second mode to a first mode for engaging the clutch or brake system.

Optionally, the method includes having the third unit co-rotate with the second unit, and temporarily changing rotation speed of the third unit relative to the second unit, e.g. by temporarily speeding up, braking or halting the second and/or third unit, for rotating the third unit from the first position to the second position, or from the second position to the first position, relative to the second unit.

Optionally, the method includes automatically resuming co-rotation of the third unit with the second unit after the third unit has been rotated from the first rotational position to the second rotational position or vice versa.

According to an aspect is provided a method for operating a clutch or brake system for a torque transmission. Such method can be practiced in a vehicle, such as a bicycle or car, a windmill or the like. The clutch or brake system has an input arranged for connection to a drive source, and an output arranged for connection to a load. Preferably, the clutch or brake system is operable under load between the input and the output. More preferably, the clutch or brake system is operable under load between the input and the output both when coupling and when decoupling. Preferably, the clutch or brake system is operable under load between the input and the output both during upshift and downshift of the torque transmission. The method includes providing a clutch or brake system. The clutch or brake system includes a first, e.g. rotatable, unit, e.g. a housing, connectable to the input or output. The clutch or brake system includes a second, e.g. rotatable, unit connectable to the output or input. The clutch or brake system includes a third, e.g. rotatable, unit arranged for co-rotating with the second unit. The third unit is arranged for selectively being in a first mode, e.g. a first rotational positon, or a second mode, e.g. a second rotational position, relative to the second unit. The system is arranged for selectively in the first mode rotationally coupling the second unit to the first unit, and in the second mode decoupling the second unit from the first unit. The method includes temporarily changing rotation speed of the third unit relative to the second unit, e.g. by temporarily speeding up, braking or halting the second and/or third unit, for bringing the third unit from the first mode to the second mode, or from the second mode to the first mode, relative to the second unit.

Optionally, the method includes rotating the third unit from the first position to the second position and from the second position to the first position in one and the same rotational direction.

Optionally, third unit includes at least one, such as at least two, actuation member arranged for moving the third unit from the first position to the second position or from the second position to the first position relative to the second unit, and the clutch or brake system includes a, e.g. non-rotatable, fourth unit including a selector, the selector being arranged for selectively being in a gripping or non-gripping mode, and the method includes with the selector in the gripping mode gripping the at least one actuation member for rotating the third unit from the first mode to the second mode or from the second mode to the first mode relative to the second unit, and with the selector in the non-gripping mode not engaging the at least one actuation member. The selector in the non-gripping mode can allowing the third unit to freely rotate with the second unit.

According to an aspect is provided a method for operating a clutch or brake system for a torque transmission. Such method can be practiced in a vehicle, such as a bicycle or car, a windmill or the like. The clutch or brake system has an input arranged for connection to a drive source, and an output arranged for connection to a load. Preferably, the clutch or brake system is operable under load between the input and the output. More preferably, the clutch or brake system is operable under load between the input and the output both when coupling and when decoupling. Preferably, the clutch or brake system is operable under load between the input and the output both during upshift and downshift of the torque transmission. The method includes providing a clutch or brake system. The clutch or brake system includes a first, e.g. rotatable, unit, e.g. a housing, connectable to the input. The clutch or brake system includes a second, e.g. rotatable, unit connectable to the output. It is also possible that the first unit is connectable to the output and the second unit is connectable to the input. The clutch or brake system includes a third, e.g. rotatable, unit arranged for co-rotating with the second unit. The third unit is arranged for selectively being in a first mode, e.g. a first rotational positon, or a second mode, e.g. a second rotational position, relative to the second unit. The system is arranged for selectively in the first mode rotationally coupling the second unit to the first unit, and in the second mode decoupling the second unit from the first unit. The third unit includes at least one, e.g. as at least two, actuation member arranged for bringing, e.g. moving, the third unit from a first mode, such as a first position (e.g. the first position or a first position of a plurality of first positions), to a second mode, such as a second position (e.g. the second position or a second position of a plurality of second positions), or from a second mode, such as a second position (e.g. the second position or a second position of the plurality of second positions), to a first mode, such as a first position (e.g. the first position or a first position of the plurality of first positions), relative to the second unit. The clutch or brake system includes a, e.g. non-rotatable, fourth unit. The fourth unit includes a selector. The selector is arranged for selectively being in a gripping or non-gripping mode. The method includes with the selector in the gripping mode gripping the at least one actuation member for bringing, e.g. rotating, the third unit from a first mode, such as a first position (e.g. the first position or a first position of the plurality of first positions), to a second mode, such as a second position (e.g. the second position or a second position of the plurality of second positions), or from a second mode, such as a second position (e.g. the second position or a second position of the plurality of second positions), to a first mode, such as a first position (e.g. the first position or a first position of the plurality of first positions), relative to the second unit; and with the selector in the non-gripping mode not engaging the at least one actuation member. The selector in the non-gripping mode can allow the third unit to freely rotate with the second unit.

Optionally, the first unit includes at least one first abutment surface, and the second unit includes at least one second abutment surface arranged for selectively engaging the first abutment surface, and the third unit includes at least one retaining member, and the method includes in the first position locking the at least one second abutment surface in engagement with the at least one first abutment surface for rotationally coupling the second unit to the first unit, and in the second position releasing the at least one second abutment surface for disengagement of the at least one first abutment surface for decoupling the second unit from the first unit.

Optionally, the actuation member is biased into contact with the selector.

Optionally, the method includes, e.g. actively, moving the at least one actuation member out of engagement with the selector after the third unit has been rotated from the first position to the second position, or from the second position to the first position.

Optionally, the selector includes a groove including a first partial groove and a second partial groove, and the method includes in gripping mode allowing, e.g. aligning, the partial grooves to engage the at least one actuation member, and in non-gripping mode allowing, e.g. dis-aligning, the partial grooves to prevent engagement of the at least one actuation member.

Optionally, the third unit includes two actuation members, optionally arranged such that when the first actuation member is in contact with the selector, the second actuation member maintained at a distance from the selector and vice versa, and the method includes selectively setting the selector in a first mode or in a second mode, wherein in the first mode the selector is in gripping mode for the first actuation member and in non-gripping mode for the second actuation member, and in the second mode the selector is in non-gripping mode for the first actuation member and in gripping mode for the second actuation member.

Optionally, the selector includes a groove including a first partial groove, a second partial groove and a third partial groove, wherein in the first mode the first and second partial grooves allow, e.g. align for, gripping the first actuation member and optionally not engaging the second actuation member, and in the second mode the second and third grooves allow, e.g. align for, gripping the second actuation member and optionally not engaging the first actuation member.

Optionally, the method includes moving the second and third partial grooves, e.g. simultaneously, in opposite directions.

Optionally, the method includes moving the second partial groove in the same direction as the first actuation member when the second partial groove moves from the non-gripping mode to the gripping mode for the first actuation member, and moving the third partial groove in the same direction as the second actuation member when the third partial groove moves from the non-gripping mode to the gripping mode for the second actuation member.

It will be appreciated that any one or more of the above aspects, features and options can be combined. It will be appreciated that any one of the options described in view of one of the aspects can be applied equally to any of the other aspects. It will also be clear that all aspects, features and options described in view of the clutch system apply equally to the transmission system, method, and vice versa.

### BRIEF DESCRIPTION OF THE DRAWING

The invention will further be elucidated on the basis of exemplary embodiments which are represented in a drawing. The exemplary embodiments are given by way of non-limitative illustration. It is noted that the figures are only schematic representations of embodiments of the invention that are given by way of non-limiting example.

In the drawing:

FIG. 1 shows an example of a transmission system;

FIG. 2 shows an example of a transmission system;

FIG. 3 shows an example of a transmission system;

FIG. 4 shows an example of a transmission system;

FIG. 5 shows an example of a transmission system;

FIG. 6 shows an example of a transmission system;

FIG. 7 shows an example of a transmission system;

FIG. 8 shows an example of a transmission system;

FIG. 9 shows an example of a clutch or brake system;

FIG. 10 shows an example of a clutch or brake system;

FIG. 11 shows an example of a clutch or brake system;

FIGS. 12a, 12b and 12c show an example of a clutch or brake system;

FIG. 13 shows an example of a clutch or brake system;

FIG. 14 shows an example of a clutch or brake system;

FIG. 15 shows an example of a clutch or brake system;

FIGS. 16a-16d show an example of gripping and ungripping the actuation members;

FIG. 17 shows an example of a clutch or brake system;

FIG. 18 shows an example of a clutch or brake system;

FIG. 19 shows an example of a clutch or brake system;

FIG. 20 shows an example of a clutch or brake system;

FIG. 21 shows an example of a transmission system;

FIG. 21 shows an example of a transmission system;

FIG. 22 shows an example of a transmission system;

FIG. 23 shows an example of a transmission system;

FIG. 24 shows an example of a transmission system;

FIG. 25 shows an example of a transmission system;

FIG. 26 shows an example of a transmission system;

FIG. 27 shows an example of a transmission system;

FIGS. 28a-28c show schematic examples of a torque transmission;

FIGS. 29a-29c show schematic examples of a torque transmission;

FIG. 30 shows an example of a wheel axle assembly;

FIGS. 31a and 31d show an example of a clutch or brake system at a first relative rotational position;

FIGS. 31b and 31e show an example of a clutch or brake system at a second relative rotational position;

FIGS. 31c and 31f show an example of a clutch or brake system at a third relative rotational position;

FIG. 31g show a detail of a clutch or brake system of FIGS. 31a and 31d;

FIG. 31h show a detail of a clutch or brake system of FIGS. 31b and 31e;

FIG. 31i show a detail of a clutch or brake system of FIGS. 31c and 31f;

FIG. 32A shows an example of a wheel axle assembly;

FIG. 32B shows an example of a wheel axle assembly.

### DETAILED DESCRIPTION

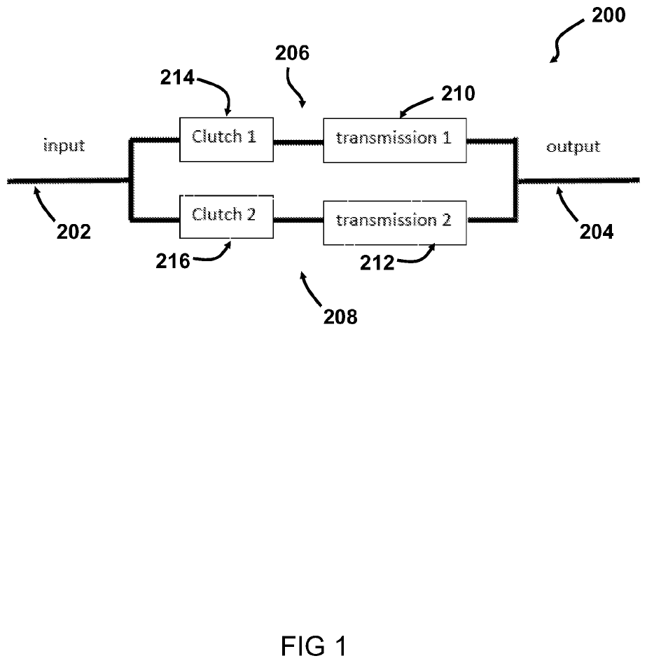

FIG. 1 shows an example of a prior art transmission system 200 for a bicycle. The system includes an input 202 arranged to be connected to a crank. The system includes an output 204 arranged to be connected to a driven wheel of the bicycle. The system 200 includes a first transmission path 206 and a second transmission path 208. The first 206 and second 208 transmission paths are arranged in parallel. The first transmission path 206 includes a first transmission 210 having a first transmission ratio. The second transmission path 208 includes a second transmission 212 having a second, different transmission ratio. The first transmission path 206 includes a first transmission clutch 214. The second transmission path 208 includes a second transmission clutch 216. For selecting the first transmission, the first transmission clutch 214 is coupled and the second transmission clutch 216 is decoupled. For selecting the second transmission, the first transmission clutch 214 is decoupled and the second transmission clutch 216 is coupled. The first and second transmission clutches in this example cannot be decoupled under load. The first and second transmission clutches 214, 216 can for example be a one-way bearing, a one-way clutch, a dog clutch, or a spline clutch.

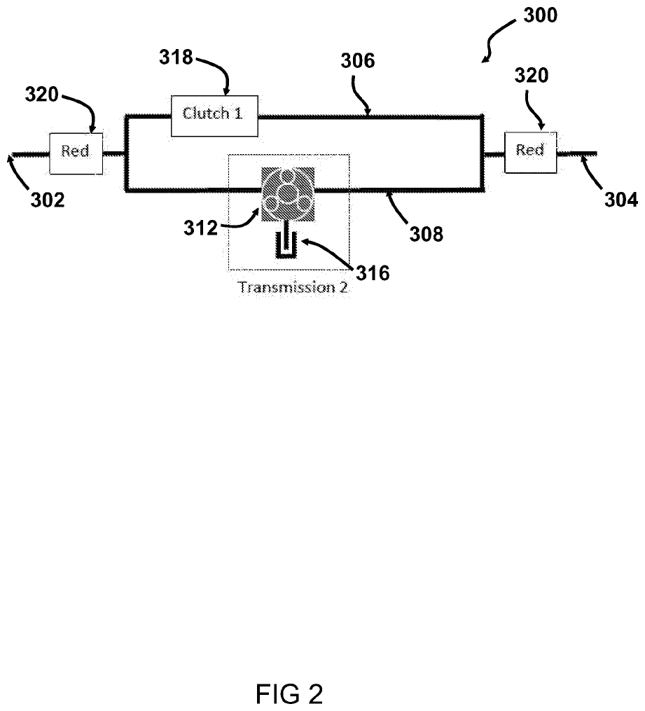

FIG. 2 shows an example of a transmission system 300, such as for a two wheeled bicycle. The transmission system 300 includes an input 302 arranged to be connected to a crank and/or an electric motor and/or a user input. The system includes an output 304 arranged to be connected to a driven wheel. The system 300 includes two parallel transmission paths 306, 308 from the input to the output. Here the second transmission path includes a second transmission 312. In this example, the second transmission is embodied as a planetary gear set.

The planetary gear set comprises at least three rotational members and a friction element, such as a brake. The at least three rotational members can include a sun gear, a planet carrier and a ring gear. Input 302 can be connected to a first rotational member of the planetary gear set. The output 304 can be connected to a second rotational member of the planetary gear set. A third rotational member of the planetary gear set can be associated with the first friction element, such as a friction brake. The brake can form the transmission clutch 316. Here the second transmission path 306 includes a second transmission clutch 316. The second transmission clutch 316 cannot be decoupled under load. Here the second transmission clutch 316 includes a one-way bearing or a one-way clutch. In the example of FIG. 2, the first transmission path 306 includes a load-shifting clutch 318. The load-shifting clutch 318 is a form closed clutch arranged to transfer torque in at least one rotational direction. The load-shifting clutch 318 is arranged for being coupled and decoupled under load, i.e. when transferring load.

Here, when the load-shifting clutch 318 is coupled, torque is transferred from the input 302 via the load-shifting clutch 318 via the first transmission path 306 to the output 304. The second transmission 312 in the second transmission path 308 will not transfer torque, and will e.g. be overrun via the second transmission clutch. Decoupling the load-shifting clutch 318 under load will cause torque to be transferred via the second transmission path 308 via the second transmission 312. Shifting from the first transmission path to the second transmission path is done without loss of torque, and under load. Again coupling the load-shifting clutch 318 will cause torque to be transferred from the input 302 via the load-shifting clutch 318 via the first transmission path 306 to the output 304 again. Shifting from the second transmission path to the first transmission path is done without loss of torque, and under load.

In the example of FIG. 2 a reduction 320 can be placed between the input 302 and the transmission paths 306, 308, and/or between the transmission paths 306, 308 and the output 304.

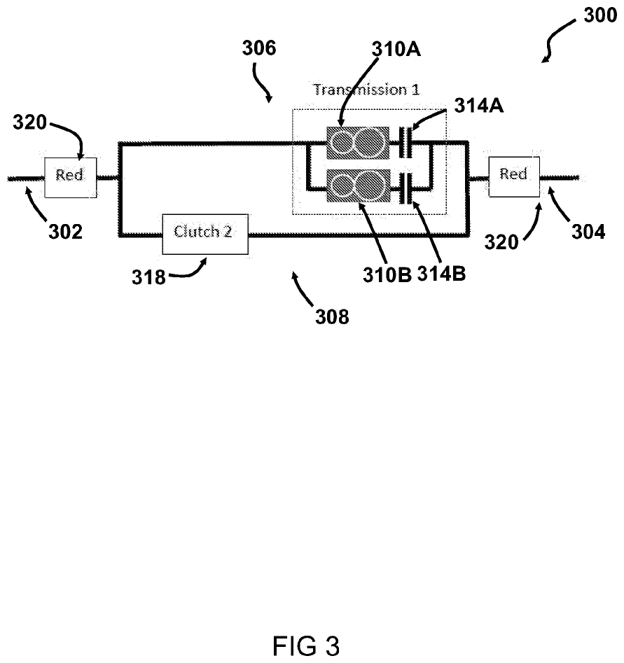

FIG. 3 shows an example of a transmission system 300, such as for a two wheeled bicycle. The transmission system 300 includes an input 302 arranged to be connected to a crank and/or an electric motor and/or a user input. The system includes an output 304 arranged to be connected to a driven wheel. The system 300 includes two parallel transmission paths 306, 308 from the input to the output. Here the first transmission path 306 includes a first first transmission 310A and a second first transmission 310B. The first first transmission 310A is connectable to the output 304 via a first first transmission clutch 314A. The second first transmission 310B is connectable to the output 304 via a second first transmission clutch 314B. Here, the first first transmission 310A includes transmission elements, here gear wheels, for forming a first first transmission ratio. Here, the second first transmission 310B includes transmission elements, here gear wheels, for forming a second first transmission ratio. It will be appreciated that the first first transmission ratio can differ from the second first transmission ratio. The first and second first transmission clutches 314A, 314B cannot be decoupled under load. Here the second transmission clutch 316 includes a one-way bearing or a one-way clutch. In the example of FIG. 3, the second transmission path 308 includes a load-shifting clutch 318. The load-shifting clutch 318 is a form closed clutch arranged to transfer torque in at least one rotational direction. The load-shifting clutch 318 is arranged for being coupled and decoupled under load, i.e. when transferring load.

Here, when the load-shifting clutch 318 is decoupled and the first first transmission clutch 314A is coupled, torque is transferred from the input 302 via via the first transmission path 306 via the first first transmission 310A and the first first transmission clutch 314A to the output 304. Coupling the load-shifting clutch 318 under load will cause torque to be transferred via the second transmission path 308 to the output 304. Shifting from the first transmission path to the second transmission path is done without loss of torque, and under load. While the load-shifting clutch is coupled, the first first transmission clutch 314A can be decoupled and the second first transmission clutch can be preselected. Now, decoupling the load-shifting clutch 318 under load will cause torque to be transferred via the first transmission path 306 via the second first transmission 310B and the second first transmission clutch 314B to the output 304. Shifting from the second transmission path to the first transmission path is done without loss of torque, and under load.

In the example of FIG. 3 a reduction 320 can be placed between the input 302 and the transmission paths 306, 308, and/or between the transmission paths 306, 308 and the output 304.

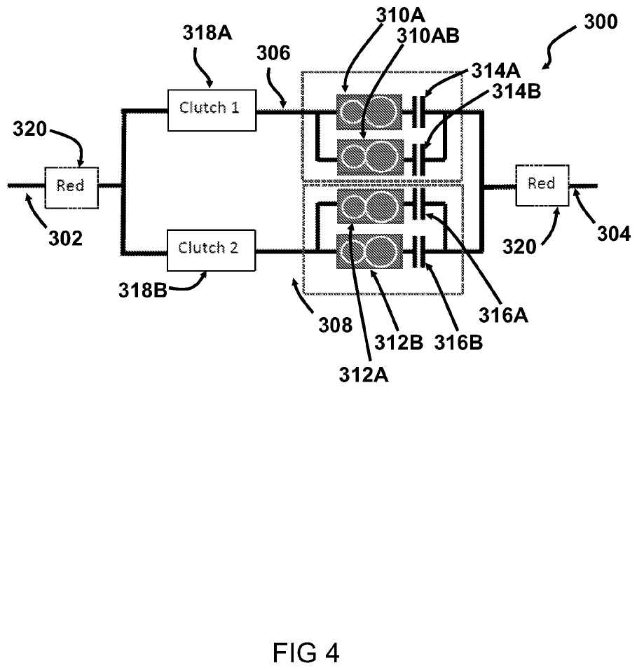

FIG. 4 shows an example of a transmission system 300, such as for a two wheeled bicycle. Features in common with the system 300 as described in view of FIGS. 2 and 3 will not be discussed in detail. Here the first transmission path 306 includes a first first transmission 310A and a second first transmission 310B. The first first transmission 310A is connectable to the output 304 via a first first transmission clutch 314A. The second first transmission 310B is connectable to the output 304 via a second first transmission clutch 314B. Here the second transmission path 308 includes a first second transmission 312A and a second second transmission 312B. The first second transmission 312A is connectable to the output 304 via a first second transmission clutch 316A. The second second transmission 312B is connectable to the output 304 via a second second transmission clutch 316B. The transmission clutches 314A, 314B, 316A, 316B need not be decouplable under load. In this example, the transmission clutches are dog clutches, or a spline clutches. Here, the first first transmission 310A includes transmission elements, here gear wheels, for forming a first first transmission ratio. Here, the second first transmission 310B includes transmission elements, here gear wheels, for forming a second first transmission ratio. Here, the first second transmission 312A includes transmission elements, here gear wheels, for forming a first second transmission ratio. Here, the second second transmission 312B includes transmission elements, here gear wheels, for forming a second second transmission ratio. It will be apreciated that the first first transmission ratio, the first second transmission ratio, the second first transmission ratio, and the second second transmission ratio can all be different.

In the example of FIG. 4, the first transmission path 306 includes a first load-shifting clutch 318A, and the second transmission path 308 includes a second load-shifting clutch 318B. The load-shifting clutches 318A, 318B are a form closed clutches arranged to transfer torque in at least one rotational direction. The load-shifting clutches 318A, 318B are arranged for being coupled and decoupled under load, i.e. when transferring load.

Here, when the first load-shifting clutch 318A is coupled one of the first or second second transmission clutches 316A, 316B can be preselected. Then, decoupling the first load-shifting clutch 318A under load and coupling the second load-shifting clutch under load will cause torque to be transferred via the second transmission path 308 to the output 304. When the second load-shifting clutch 318B is coupled one of the first or second first transmission clutches 314A, 314B can be preselected. Preferably, preselecting of a transmission element is performed only in the transmission path via which no, or limited, torque is transmitted at the moment of actuation. The transmission clutches 314A, 314B, 316A, 316B and the load-shifting clutches 318A, 318B are arranged for being operated independently. Actuators for actuation of the transmission clutches 314A, 314B, 316A, 316B and actuators for actuation of the load-shifting clutches 318A, 318B are arranged for being operated independently. The actuators for actuation of the at least one load-shifting clutch and the at least one transmission clutch can be arranged for being operated electronically by an actuator controller.

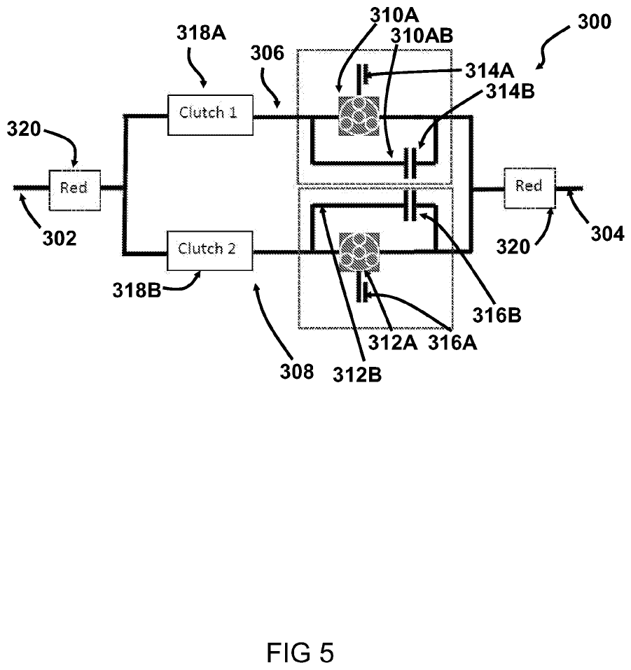

FIG. 5 shows an example of a transmission system 300, such as for a two wheeled bicycle. Features in common with the system 300 as described in view of FIGS. 2, 3 and 4 will not be discussed in detail. Here the first transmission path 306 includes a first first transmission 310A and a second first transmission 310B. The first first transmission here is a first planetary gear set. A first first transmission clutch 314A allows braking one of the rotational members of the first planetary gear set for engaging the first first transmission 310A, the second first transmission clutch (here a one-way bearing, a one-way clutch) overrunning. When the first first transmission clutch is released, the second first transmission clutch will allow transmitting torque to the output via the second first transmission 310B. Similarly, the second transmission path 308 includes a first second transmission 312A and a second second transmission 312B. The first second transmission here is a second planetary gear set. A first second transmission clutch 316A allows braking one of the rotational members of the second planetary gear set for engaging the first second transmission 310A, the second second transmission clutch (here a one-way bearing, a one-way clutch) overrunning. When the first second transmission clutch is released, the second second transmission clutch will allow transmitting torque to the output via the second second transmission 312B. In the example of FIG. 5, the first transmission path 306 includes a first load-shifting clutch 318A, and the second transmission path 308 includes a second load-shifting clutch 318B. The load-shifting clutches 318A, 318B are a form closed clutches arranged to transfer torque in at least one rotational direction. The load-shifting clutches 318A, 318B are arranged for being coupled and decoupled under load, i.e. when transferring load.

Here, when the first load-shifting clutch 318A is coupled one of the first or second first transmissions 310A, 310B can transmit torque from the input 302 to the output 304. Then, decoupling the first load-shifting clutch 318A under load and coupling the second load-shifting clutch under load will cause torque to be transferred via the second transmission path 308 to the output 304. When the second load-shifting clutch 318B is coupled one of the first or second second transmissions 312A, 312B can transmit torque from the input 302 to the output 304.

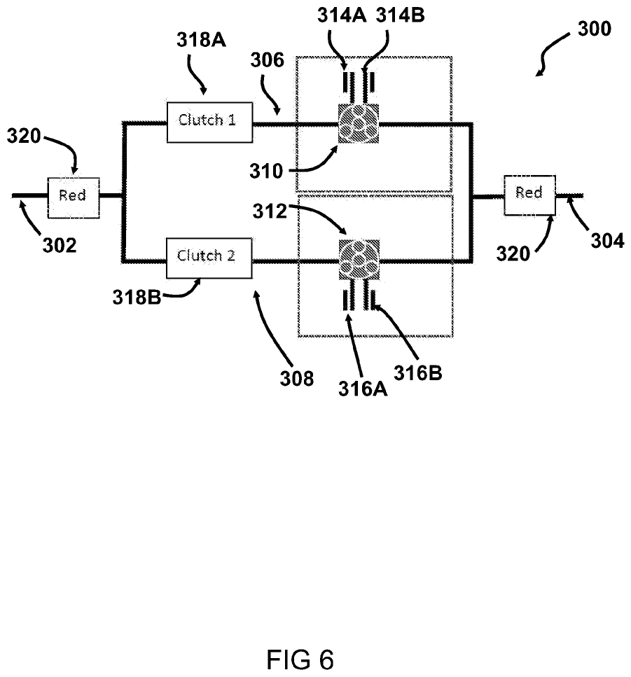

FIG. 6 shows an example of a transmission system 300, such as for a two wheeled bicycle. Features in common with the system 300 as described in view of FIGS. 2, 3, 4 and 5 will not be discussed in detail. Here the first transmission path 306 includes a first transmission 310 embodied as a first planetary gear set. The planetary gear set can comprise at least four rotational members and two brakes. The input 302 can be connected to a first rotational member of the planetary gear set. The output 304 can be connected to a second rotational member of the planetary gear set. A third rotational member of the planetary gear set can be associated with the first friction element, such as a first friction brake. A fourth rotational member of the planetary gear set can be associated with the further friction element, such as a second friction brake. The first brake can form the first first transmission clutch 314A. The second brake can form the second first transmission clutch 314B. The first first transmission clutch 314A allows braking one (the third) of the rotational members of the planetary gear set. The second first transmission clutch 314B allows braking a different one (the fourth) of the rotational members of the first planetary gear set. By braking either the first first transmission clutch or the second first transmission clutch, the planetary gear set provides a first first transmission ratio or a different second first transmission ratio. Similarly, the second transmission path 308 includes a second transmission 312 embodied as a second planetary gear set. A first second transmission clutch 316A allows braking one of the rotational members of the planetary gear set. A second second transmission clutch 316B allows braking a different one of the rotational members of the planetary gear set. By braking either the first second transmission clutch or the second second transmission clutch, the second planetary gear set provides a first second transmission ratio or a different second second transmission ratio. In the example of FIG. 6, the first transmission path 306 includes a first load-shifting clutch 318A in series with the first transmission 310, and the second transmission path 308 includes a second load-shifting clutch 318B in series with the second transmission 312. The load-shifting clutches 318A, 318B are a form closed clutches arranged to transfer torque in at least one rotational direction. The load-shifting clutches 318A, 318B are arranged for being coupled and decoupled under load, i.e. when transferring load.

Here, when the first load-shifting clutch 318A is coupled the first transmissions 310 can transmit torque from the input 302 to the output 304 according to a first or second first transmission ratio. Then, decoupling the first load-shifting clutch 318A under load and coupling the second load-shifting clutch under load will cause torque to be transferred via the second transmission path 308 to the output 304. When the second load-shifting clutch 318B is coupled the second transmissions 312 can transmit torque from the input 302 to the output 304 according to a first or second second transmission ratio.

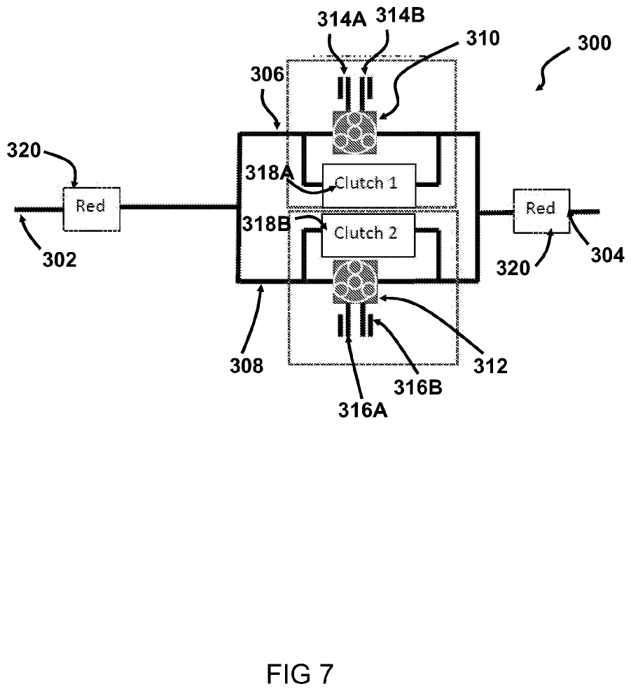

FIG. 7 shows an example of a transmission system 300, such as for a two wheeled bicycle. Features in common with the system 300 as described in view of FIGS. 2, 3, 4, 5 and 6 will not be discussed in detail. In the example of FIG. 7, the first transmission path 306 includes a first load-shifting clutch 318A i parallel with the first transmission 310, and the second transmission path 308 includes a second load-shifting clutch 318B in parallel with the second transmission 312. The load-shifting clutches 318A, 318B are a form closed clutches arranged to transfer torque in at least one rotational direction. The load-shifting clutches 318A, 318B are arranged for being coupled and decoupled under load, i.e. when transferring load.

Here, when the first load-shifting clutch 318A is coupled the first transmissions path 306 can transmit torque from the input 302 to the output 304 with unity transmission ratio. With the first load-shifting clutch 318A decoupled, the first transmission 310 can transmit torque according to a first or second first transmission ratio. When the second load-shifting clutch 318B is coupled the second transmissions 312 can transmit torque from the input 302 to the output 304 with unity transmission ratio. With the second load-shifting clutch 318B decoupled, the second transmission 312 can transmit torque according to a first or second second transmission ratio.

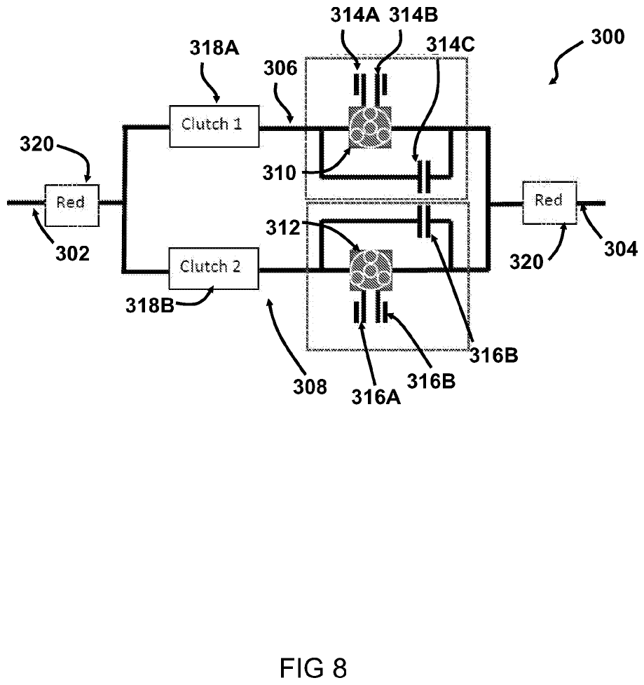

FIG. 8 shows an example of a transmission system 300, such as for a two wheeled bicycle. Features in common with the system 300 as described in view of FIGS. 2, 3, 4, 5, 6 and 7 will not be discussed in detail. Here the first transmission path 306 includes a first transmission 310 embodied as a first planetary gear set. A first first transmission clutch 314A allows braking one of the rotational members of the planetary gear set. A second first transmission clutch 314B allows braking a different one of the rotational members of the first planetary gear set. By braking either the first first transmission clutch or the second first transmission clutch, the planetary gear set provides a first first transmission ratio or a second first transmission ratio. A third first transmission clutch 314C is provided in parallel with the first planetary gear set. Here, the third first transmission clutch 314C is a one-way bearing or a one-way clutch. If the first or second first transmission clutch 314A, 314B is braked, the third first transmission clutch 314C will overrun. If none of first or second first transmission clutches 314A, 314B is braked, the third first transmission clutch 314C will allow transferring torque to the output 304. Similarly, the second transmission path 308 includes a second transmission 312 embodied as a second planetary gear set. A first second transmission clutch 316A allows braking one of the rotational members of the planetary gear set. A second second transmission clutch 316B allows braking a different one of the rotational members of the planetary gear set. By braking either the first second transmission clutch or the second second transmission clutch, the second planetary gear set provides a first second transmission ratio or a second second transmission ratio. A third second transmission clutch 316C is provided in parallel with the second planetary gear set. Here, the third second transmission clutch 316C is a one-way bearing or a one-way clutch. If the first or second second transmission clutch 316A, 316B is braked, the third second transmission clutch 316C will overrun. If none of first or second second transmission clutches 316A, 316B is braked, the third second transmission clutch 316C will allow transferring torque to the output 304. In the example of FIG. 8, the first transmission path 306 includes a first load-shifting clutch 318A in series with the first transmission 310, and the second transmission path 308 includes a second load-shifting clutch 318B in series with the second transmission 312. The load-shifting clutches 318A, 318B are a form closed clutches arranged to transfer torque in at least one rotational direction. The load-shifting clutches 318A, 318B are arranged for being coupled and decoupled under load, i.e. when transferring load.

Here, when the first load-shifting clutch 318A is coupled the first transmissions 310 can transmit torque from the input 302 to the output 304 according to a first or second first transmission ratio of the first planetary gear set, or via the third second transmission clutch 314C. Then, decoupling the first load-shifting clutch 318A under load and coupling the second load-shifting clutch under load will cause torque to be transferred via the second transmission path 308 to the output 304. When the second load-shifting clutch 318B is coupled the second transmissions 312 can transmit torque from the input 302 to the output 304 according to a first or second second transmission ratio of the second planetary gear set, or via the third second transmission clutch 316C.

It will be appreciated that in all of the systems 300 of FIGS. 2-8 the transmission clutch 318, or transmission clutches 318A, 318B, can be actuated with a mechanical, electrical and/or hydraulical actuator.

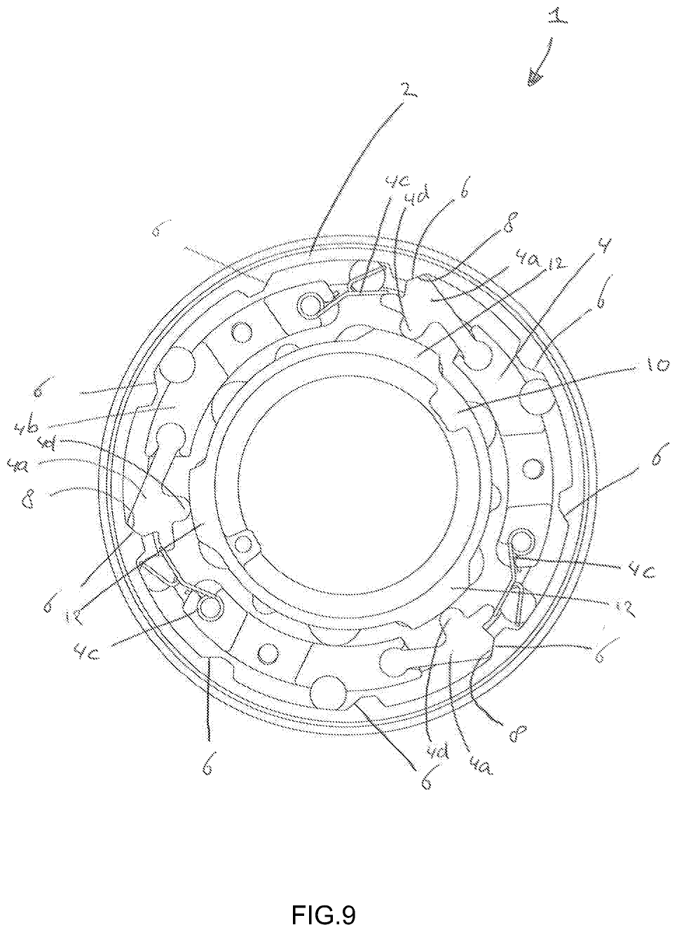

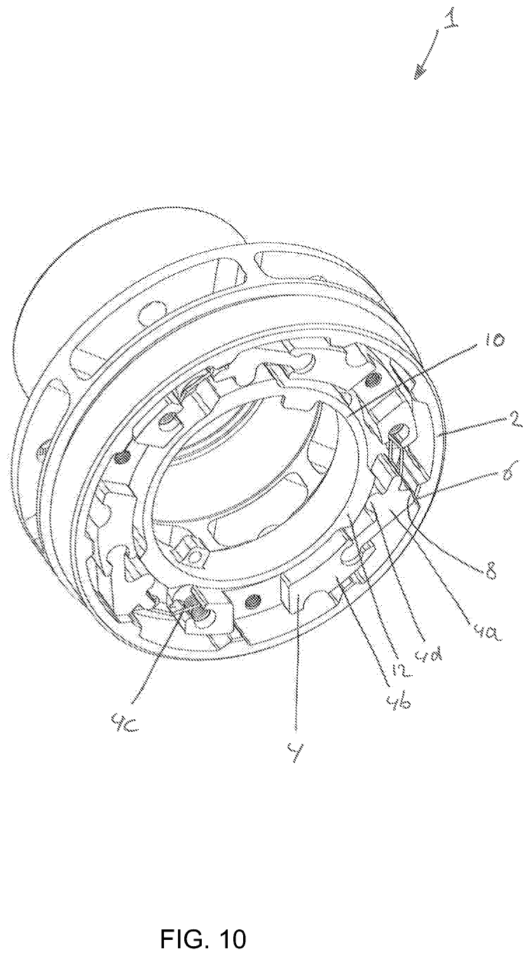

FIGS. 9, 10 and 11 show an example of a clutch system 1. The clutch system 1 of this example is for use in a torque transmission of a bicycle, however, other fields of use can be envisioned. The clutch system 1 can be used as load-shifting clutch 318, 318A, 318B in the transmission system 300 as described in view of FIGS. 2-8. The clutch system 1 has an input arranged for connection to a drive source, such as pedals or a chain/belt. The clutch system has an output arranged for connection to a load, such as a rear wheel hub. The exemplary clutch system 1 is operable under load between the input and the output, e.g. while pedaling. Hence, the clutch system 1 can be coupled or decoupled under load. Here, the clutch system is operable under load between the input and the output both during upshift and downshift of the torque transmission.

The clutch system in FIGS. 9, 10 and 11 includes a first, in this example rotatable, unit 2. The first rotatable unit 2 is arranged to be connected to the input. Here, the first rotatable unit 2 is designed as a housing part of the clutch system 1. The clutch system 1 includes a second, in this example rotatable, unit 4. The second rotatable unit 4 is arranged to be connected to the output. The first rotatable unit 2 includes at least one first abutment surface 6. In this example, the first rotatable unit 2 includes nine first abutment surfaces 6, here evenly distributed along the perimeter of the first rotatable unit 2 at 40 degrees mutual spacing. The second rotatable unit 4 includes at least one second abutment surface 8. In this example, the second rotatable unit 4 includes three second abutment surfaces 8, here evenly distributed along the perimeter of the second rotatable unit 4 at 120 degrees mutual spacing. It will be appreciated that in this example the second rotatable unit 4 includes a plurality of gripping members 4a, here embodied as separate parts hingedly connected to a body portion 4b of the second rotatable unit 4. In this example, the second abutments surfaces 8 are part of the gripping members 4a of the second rotatable unit 4. The second abutment surfaces 8, here the gripping members 4a, are each arranged for selectively engaging one of the first abutment surfaces 6. In the example of FIG. 9 it can be seen that the first and second abutment surfaces are oriented at an angle relative to a radial direction of the first and second rotatable units, respectively. This allows the first and second abutment surfaces are to disengaging under load. In this example, the second rotatable unit 4 includes resilient members 4c, here helical springs, arranged so as to bias the second abutment surfaces 8 out of engagement with the first abutment surfaces 6.

The clutch system 1 in FIGS. 9, 10 and 11 includes a third, in this example rotatable, unit 10. The third rotatable unit 10 is arranged for co-rotating with the second rotatable unit 4. That is, in use, when the output is rotating (e.g. when the driven wheel of the bicycle is rotating), i.e. when the second rotatable unit 4 is rotating, the third rotatable unit 10 generally co-rotates with the second rotatable unit 4.

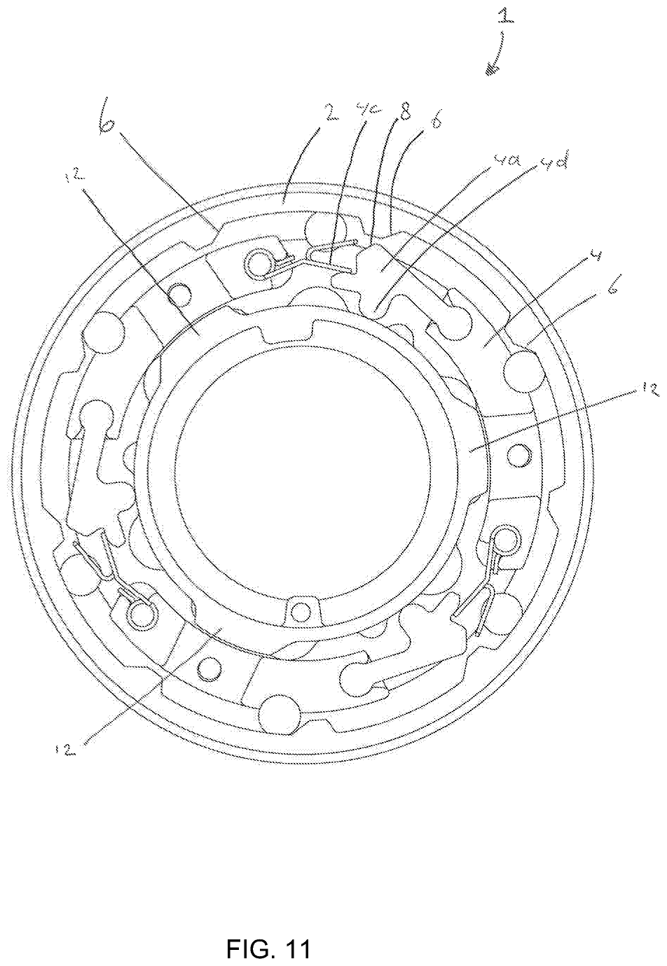

The third rotatable unit 10 includes at least one retaining member 12. In this example, the third rotatable unit 10 includes three retaining members 12, here evenly distributed along the perimeter of the third rotatable unit 10 at 120 degrees mutual spacing. The third rotatable unit 10 is arranged for selectively being in a first position (see FIG. 9) or a second position (see FIG. 11) relative to the second rotatable unit 4. It will be appreciated that in this example the first position is a first rotational position, and the second position is a second, different, rotational position.

In the first position (shown in FIG. 9), the retaining members 12 are positioned rotationally aligned with, here under, cams 4d of the gripping members 4a. Thus, in the first position, the gripping members 4a are forced to be pivoted in a radially outer position. In the first position, the second abutment surfaces 8 are positioned to be touching or close to the first abutment surfaces 6. The presence of the retaining members 12 under the cams 4a prevents the second abutment surfaces from being pivoted radially inwards sufficiently to disengage from the first abutment surfaces 6. Hence, the retaining members 12 in the first position lock the second abutment surfaces 8 in engagement with the first abutment surfaces 6. As the second abutment surfaces 8 are locked in engagement with the first abutment surfaces 6, the second rotatable unit 4 is rotationally coupled to the first rotatable unit 2.

In the second position (shown in FIG. 11), the retaining members 12 are positioned rotationally not aligned with, here out of the reach of, the cams 4d of the gripping members 4a. Thus, in the second position, the gripping members 4a are free to pivot to a radially inner position. In this example, the biasing force of the resilient members 4c pivots the second abutment surfaces 8 radially inwards sufficiently to disengage from the first abutment surfaces 6. As a result, the first rotatable unit 2 is free to rotate independently of the second rotatable unit 4. Thus, the second rotatable unit 4 is decoupled from the first rotatable unit 2.

Hence, while the first abutment surfaces 6 and second abutment surfaces 8 are adapted to each other so as to allow disengaging under load, or to disengage under load, the relative positioning of the second rotatable unit 4 and the third rotatable unit 10 can selectively in the first position lock the second abutment surfaces 8 in engagement with the first abutment surfaces 6, and in the second position release the second abutment surfaces 8 for disengagement from the first abutment surfaces 6. It will be appreciated that while the first rotatable unit 2 and second rotatable unit 4 are decoupled, rotating the third rotatable unit 10 from the first position to the second position relative to the second rotatable unit 4, will couple the first and second rotatable units. While the first rotatable unit 2 and second rotatable unit 4 are coupled, rotating the third rotatable unit 10 from the second position to the first position relative to the second rotatable unit 4, will decouple the first and second rotatable units.

Changing the position of the third rotatable unit 10 relative to the second rotatable unit 4 from the first position to the second position, or vice versa, can be performed in many different ways. Changing the position of the third rotatable unit 10 relative to the second rotatable unit 4 from the first position to the second position can be performed by rotating the third rotatable unit 10 relative to the second rotatable unit 4 in a forward direction, and changing the position of the third rotatable unit 10 relative to the second rotatable unit 4 from the second position to the first position can be performed by rotating the third rotatable unit 10 relative to the second rotatable unit 4 in an opposite, rearward direction. It is also possible to rotate the third rotatable unit 10 relative to the second rotatable unit 4 from the first position to the second position, and from the second position to the first position in one and the same rotational direction.

An actuator can be provided for rotating the third rotatable unit and/or the second rotatable unit from the first position to the second position, and/or from the second position to the first position.

In the example of FIGS. 9, 10 and 11, the third rotatable unit 10 is arranged for co-rotating with the second rotatable unit 4. Therefore, changing the position of the third rotatable unit 10 relative to the second rotatable unit 4 from the first position to the second position, or vice versa, can be performed by temporarily changing rotation speed of the third rotatable unit relative to the second rotatable unit, e.g. by temporarily speeding up, braking or halting the second and/or third rotatable unit, for rotating from the first position to the second position, or from the second position to the first position.

In the example of FIGS. 9, 10 and 11, the third rotatable unit 10 is freely rotatable relative to the second rotatable unit 4. There is no limit to the rotational displacement of the third rotatable unit 10 relative to the second rotatable unit 4. In this example, the third rotatable unit 10 is arranged for selectively being in one of a plurality of first positions or one of a plurality of second positions relative to the second rotatable unit. Each of the first positions of the plurality of first positions is defined by the third rotatable unit 10 being positioned to lock the second abutment surfaces 8 in engagement with the first abutment surfaces 6 for rotationally coupling the second rotatable unit 4 to the first rotatable unit 2. In this example there are three gripping members 4a and three retaining members 12, so there are three distinct first positions. Here, the three first positions are evenly distributed along the perimeter of the second rotatable unit 4 at 120 degrees mutual spacing. Each of the second positions of the plurality of second positions is defined by the third rotatable unit 10 being positioned to release the second abutment surfaces 8 from engagement with the first abutment surfaces 6 for rotationally decoupling the second rotatable unit 4 from the first rotatable unit 2. In this example there are three gripping members 4a and three retaining members 12, so there are three second positions. Here, the three second positions can be seen as evenly distributed along the perimeter of the second rotatable unit 4 at 120 degrees mutual spacing. It will be appreciated that the three first positions and three second positions are alternatingly placed along the perimeter of the second rotatable unit 4. For example, the three first positions and three second positions are alternatingly spaced at 60 degrees around the perimeter of the second rotatable unit.

Here, the third rotatable unit 10 can be rotated relative to the second rotatable unit 4 from a first first position to a first second position, from the first second position to a second first position, from the second first position to a second second position, from the second second position to a third first position, from the third first position to a third second position, and from the third second position to the first first position in one and the same rotational direction. The clutch system 1 can be arranged for temporarily changing rotation speed of the third rotatable unit 10 relative to the second rotatable unit 4, e.g. by temporarily speeding up, braking or halting the second and/or third rotatable unit, for rotating from a first position (e.g. the first position or a first position of the plurality of first positions) to a second position (e.g. the second position or a second position of the plurality of second positions) or from a second position (e.g. the second position or a second position of the plurality of second positions) to a first position (e.g. the first position or a first position of the plurality of first positions). Hence, the second and third rotatable units can in a simple manner be rotated from a first position to a second position or vice versa.

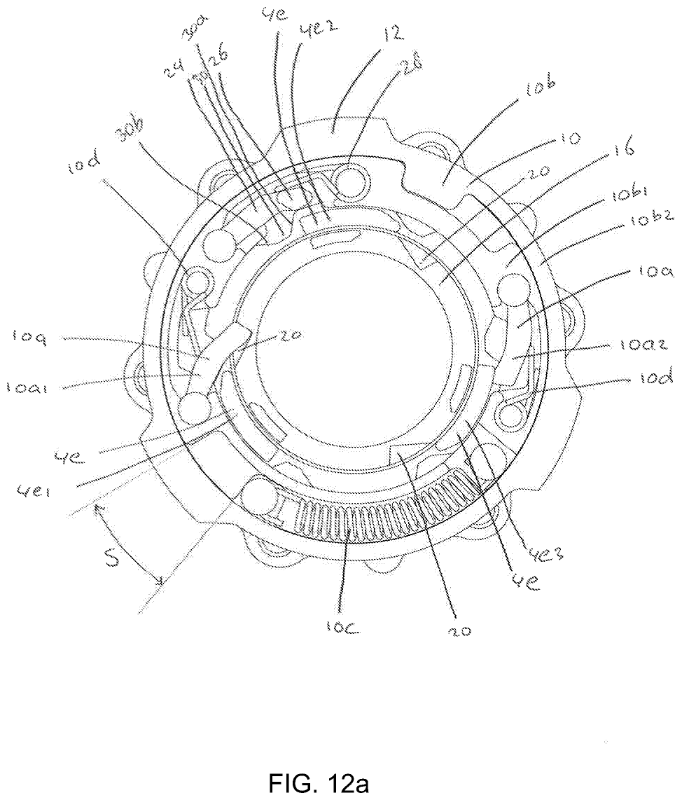

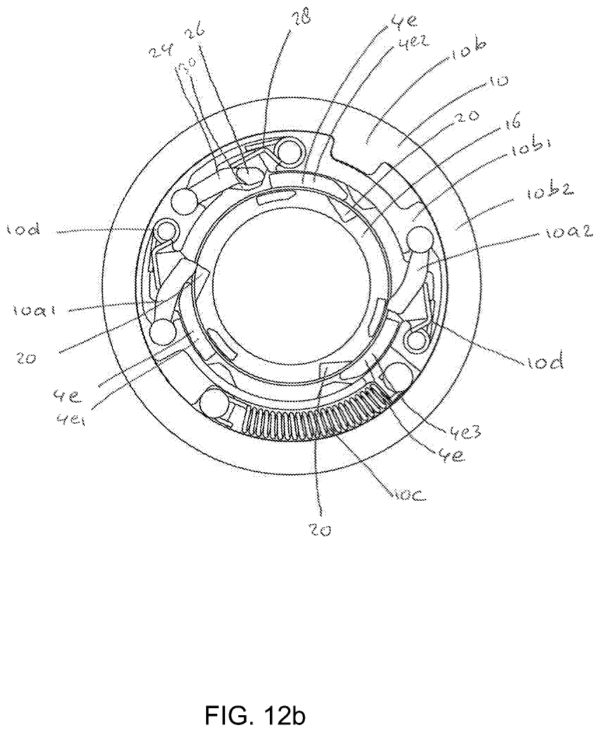

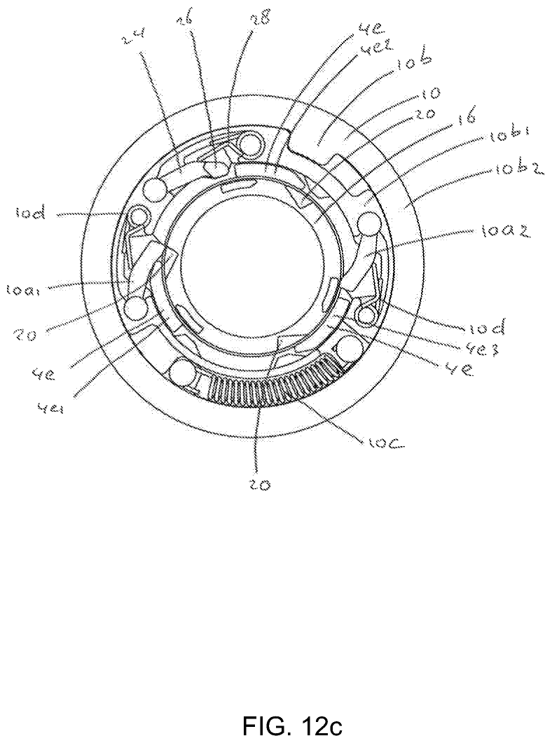

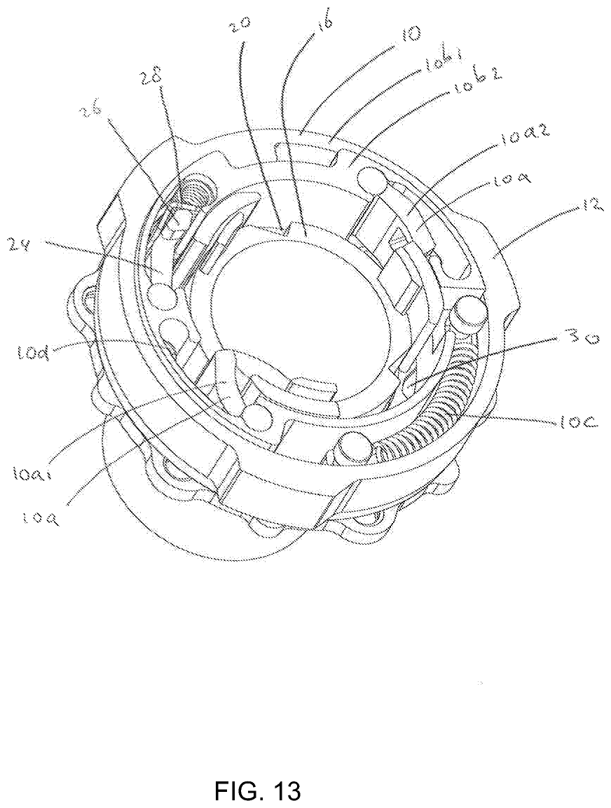

FIGS. 12a, 12b, 12c and 13 show an example of a mechanism for moving the third rotatable unit 10 from a first position (e.g. the first position or a first position of the plurality of first positions) to a second position (e.g. the second position or a second position of the plurality of second positions) or from a second position (e.g. the second position or a second position of the plurality of second positions) to a first position (e.g. the first position or a first position of the plurality of first positions) relative to the second rotatable unit.

The third rotatable unit 10 includes at least one, here two, actuation member 10a arranged for moving the third rotatable unit 10 from a first position to a second position or from a second position to a first position relative to the second rotatable unit 4. The actuation members 10a are hingedly connected to a body portion 10b of the third rotatable unit 10. In this example, the body portion 10b of the third rotatable unit 10 includes an first body portion 10b1 and a second body portion 10b2. The first body portion 10b1 hingedly receives the actuation members 10a. The second body portion 10b2 includes the retaining members 12. The first body portion 10b1 is rotatable relative to the second body portion 10b2, here over an angular stroke S. The first and second body portions 10b1, 10b2 are biased in abutment with a resilient element 10c, here a tension spring. This allows the first and second body portions to rotate relative to each other. For example, when the retaining member 12 can not yet push the gripping member 4a radially outwardly in abutment with the first abutment surface 6 the resilient element 10c allows the first body portion 10b1 to rotate relative to the first rotatable unit 2 while the second body portion 10b2 does not rotate relative to the first rotatable unit 2.

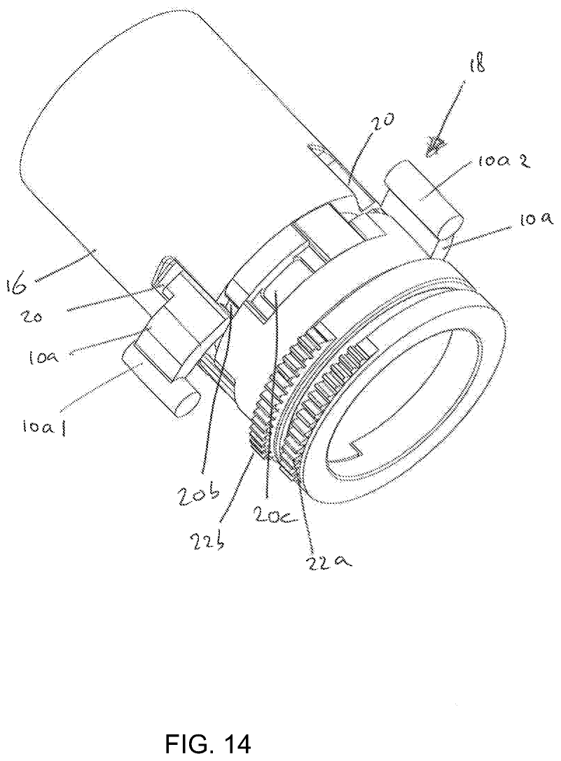

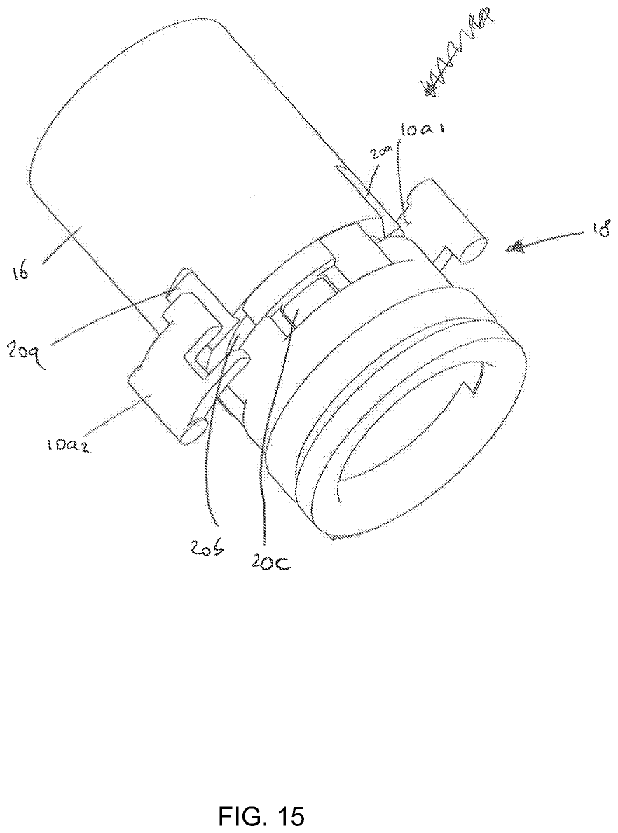

In FIGS. 12a, 12b, 12c and 13 the clutch system 1 further includes a, here non-rotatable, fourth unit 16. The fourth unit 16 can be arranged to be non-rotatably mounted to a frame of the bicycle. The fourth unit 16 is further shown in FIGS. 14 and 15. The fourth unit 16 includes a selector 18. The selector 18 is arranged for selectively being in a gripping or non-gripping mode.

As shown in FIGS. 12a-15, here the third rotatable body 10 includes two actuation members 10a. In this example, the actuation members 10a are biased towards the fourth unit 16 by resilient elements 10d, here helical springs. In this example, the second rotatable unit 4 includes three retractor members 4e. the retractor members 4e co-rotate with the body portion 4b of the second rotatable unit 4. The retractor members 4e can e.g. be fixedly connected to, or integral with, the body portion 4b. As can be seen in FIG. 12a, one of the retractor members 4e, here 4e1, allows a first actuation member 10a1 to engage the fourth unit 16, while another one of the retractor members 4e, here 4e3, prevents a second actuation member 10a2 to engage the fourth unit 16. Hence, when the first actuation member 10a1 is biased into contact with the selector 18, the second actuation member 10a2 is maintained at a distance from, e.g. non-engaged by, the selector 18, and vice versa.

As shown in FIGS. 14 and 15, in this example the selector 18 includes a groove 20. In this example, the groove 20 includes a first partial groove 20a, a second partial groove 20b and a third partial groove 20c. In a first mode the first partial groove 20a and second partial groove 20b align as shown in FIGS. 14 and 15. It is noted that in this first mode the third partial groove 20c does not align with the first partial groove 20a. In a second mode the first partial groove 20a and third partial groove 20c align. It is noted that in this second mode the second partial groove 20b does not align with the first partial groove 20a. As can be seen in FIG. 14, the first and second partial grooves 20a, 20b aligning, allows the first actuation member 10a1 to enter into the first partial groove 20a, as can also be seen in FIG. 12a. It will be noted that in this example the shape of the first actuation member 10a1, requires the first partial groove 20a and the second partial groove 20b to align for allowing the first actuation member 10a1 to enter the first partial groove 20a. The first partial groove 20a then supports the first actuation member 10al, allowing a force to be guided from the fourth unit 16 via the first actuation member 10a1 to the third rotatable unit 10. As a result, the third rotatable unit 10 will be halted, and when, in use, the second rotatable unit 4 will remain rotating, the third rotatable unit 10 will be rotated relative to the second rotatable unit 4. When the second rotatable unit 4 has rotated over approximately 60 degrees after gripping of the first actuation member 10a1 by the first partial groove 20a, the retractor member 4e1 knocks the first actuation member 10a1 out of the first partial groove 20a, as can be seen in FIGS. 4b and 4c, and the third rotatable unit 10 resumes co-rotating with the second rotatable unit 4.

In this example, the third rotatable unit 10 includes a retainer 24. In this example, the retainer 24 is hingedly connected to the body portion 10b of the third rotatable unit 10. Here, the retainer 24 includes a tooth 26. The tooth 26 is biased by a resilient element, here a spring 28. The second rotatable unit 4 includes a, here three, notch 30. Here the notch 30 has an angled face 30a. As can be seen in FIG. 12b, when the retractor member 4e1 has knocked the first actuation member 10a1 out of the first partial groove 20a the tooth 26 of the retainer 24 is on the angled face 30a of the notch 30. Due to the biasing force of the resilient element 28, the tooth 26 is pushed along the angled face 30a to the bottom of the notch 30, as can be seen in FIG. 12b. As a result, the third rotatable unit 10 assumes a defined angular position relative to the second rotatable unit 4. Also, the slight angular movement from the situation shown in FIG. 12b, with the actuation member 10a1 just freed from the groove 20, to the situation shown in FIG. 12c, enables that the retractor member 4e1 lifts the actuation member 10a1 away from the groove 20, so that mechanical contact between the actuation member 10a1 and the fourth unit 16 can be avoided.

Having been rotated over 60 degrees, the third rotatable unit 10 has been rotated from a first position to a second position, or from a second position to a first position relative to the second rotatable unit 4. Now, the first actuation member 10a1 is maintained in a non-deployed position by the retractor member 4e and is maintained at a distance from the selector 18.

At approximately the same time, the other retractor member 4e3 is also rotated and releases the second actuation member 10a2 to engage the fourth unit 16. However, as can be seen in FIG. 15, the second actuation member 10a2 cannot enter into the first partial groove 20a, as the shape of the second actuation member 10a2 requires the third partial groove 20c to align with the first partial groove 20a for allowing the second actuation member 10a2 to enter into the first partial groove 20a. The second actuation member 10a2 will slide along the surface of the selector 18 without being gripped.

For again actuating the third rotatable unit 10, the second partial groove 20b is moved out of alignment with the first partial groove 20a, and the third partial groove 20c is moved into alignment with the first partial groove 20a. In this situation, the second actuation member 10a2 can enter into the first partial groove 20a. It will be appreciated that it can be possible that the second actuation member 10a2 can already enter into the first partial groove 20a when the first partial groove 20a and the third partial groove 20c are not yet in complete alignment. Hence, the second actuation member 10a2 can already enter into the first partial groove 20a when the third partial groove 20c is still moving into alignment with the first partial groove 20a. When the second actuation member 10a2 has entered into the first partial groove, the first partial groove 20a supports the second actuation member 10a2, allowing a force to be guided from the fourth unit 16 via the second actuation member 10a2 to the third rotatable unit 10. As a result, the third rotatable unit 10 will again be halted, and when, in use, the second rotatable unit 4 will remain rotating, the third rotatable unit 10 will be rotated relative to the second rotatable unit 4. The tooth 26 of the retainer 24 will be moved out of the notch 30 by sliding over a second angled face 30b of the notch. When the second rotatable unit 4 has rotated over approximately 60 degrees after gripping of the second actuation member 10a2 by the first partial groove 20a, the retractor member 4e, now 4e2, knocks the second actuation member 10a2 out of the first partial groove 20a and the third rotatable unit 10 resumes co-rotating with the second rotatable unit 4 again. The tooth 26 of the retainer 24 will be seated at the bottom of a notch 30 again. Having been rotated over 60 degrees, the third rotatable unit 10 has been rotated from a second position to a first position, or from a first position to a second position relative to the second rotatable unit 4. Now, the second actuation member 10a2 is maintained in a non-deployed position by the retractor member 4e again and is maintained at a distance from the selector 18 as shown in FIG. 12a.

At approximately the same time, the other retractor member 4e1 is also rotated and again releases the first actuation member 10a1 to engage the fourth unit 16. However, the first actuation member 10a1 cannot enter into the first partial groove 20a, as the shape of the first actuation member 10a1 requires the second partial groove 20b to align with the first partial groove 20a for allowing the first actuation member 10a1 to enter into the first partial groove 20a. The first actuation member 10a1 will now slide along the surface of the selector 18 without being gripped.

Thus, the selector 18 can be in a first mode for gripping the first actuation member and for not engaging the second actuation member, and in a second mode for gripping the second actuation member and not engaging the first actuation member.

It will be appreciated that in this example, forces from the third rotatable unit 10 via, the actuation members 10a are supported by the first partial groove 20a only. The second and third partial grooves 20b, 20c absorb no, or hardly any, force. The second and third partial grooves merely act as keys to select whether the first or second actuation member can enter the first partial groove 20a or not.

In the example of FIG. 14, it can be seen that the fourth unit 16 includes two toothed racks 22a, 22b. The first toothed rack 22a is connected to a bush carrying the second partial groove 20b. The second toothed rack 22b is connected to a bush carrying the third partial groove 20c. The toothed racks 22a, 22b can be driven by pinions of one or two electric motors.

In the example of FIGS. 14 and 15, the second partial groove 20b and the third partial groove 20c are arranged to be moved relative to the first partial groove 20a in a tangential displacement. Here the second and third partial grooves 20b, 20c are arranged to be moved simultaneously in opposite directions. In this example, the second partial groove 20b is arranged for moving in the same direction the as the first actuation member 10al, i.e. along with the sliding of the first actuation member 10a1 along the surface of the selector 18, when the second partial groove 20b moves from the non-gripping mode to the gripping mode for the first actuation member 10a1. The third partial groove 20c is arranged for moving in the same direction as the second actuation member 10a2, i.e. along with the sliding of the second actuation member 10a2 along the surface of the selector 18, when the third partial groove 20c moves from the non-gripping mode to the gripping mode for the second actuation member 10a2. Hence, forces on the selector 18 are minimized, and symmetrical for both actuation members 10a.

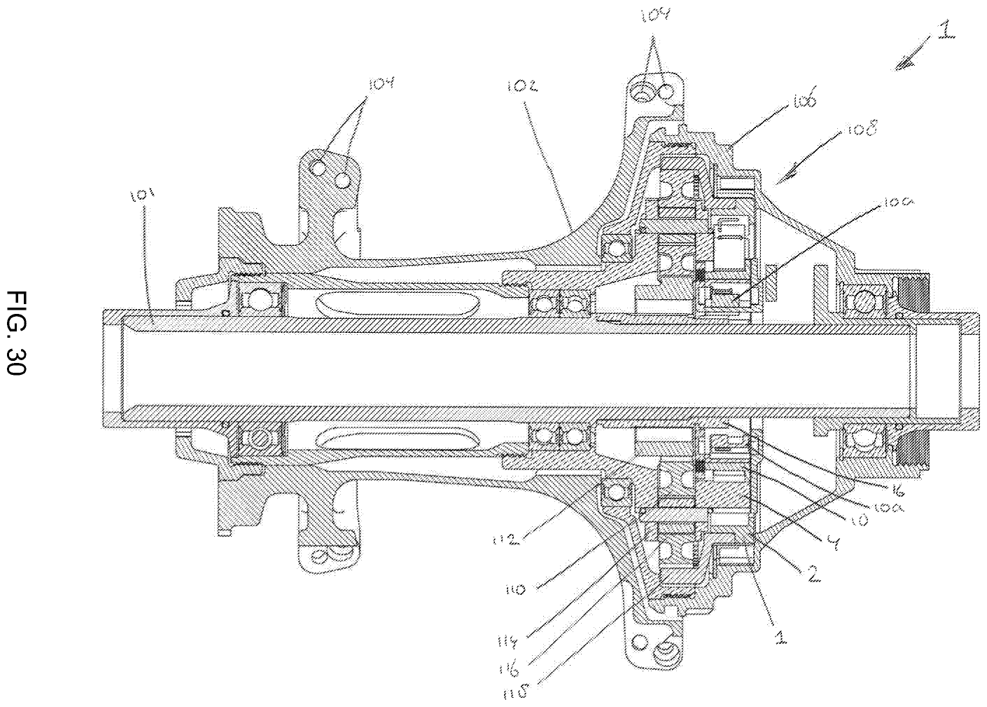

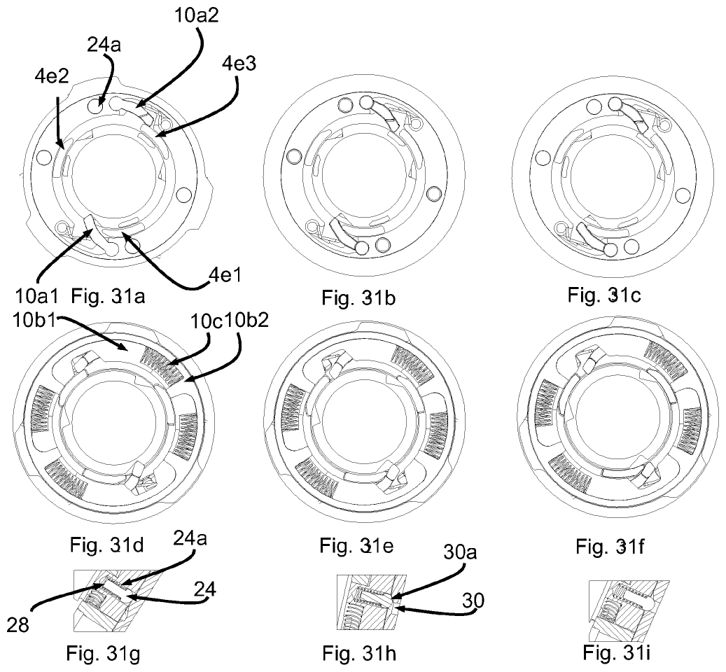

FIGS. 31a-31i show another example of a mechanism for moving the third rotatable unit 10 from a first position (e.g. the first position or a first position of the plurality of first positions) to a second position (e.g. the second position or a second position of the plurality of second positions) or from a second position (e.g. the second position or a second position of the plurality of second positions) to a first position (e.g. the first position or a first position of the plurality of first positions) relative to the second rotatable unit. The mechanism is similar to that described in view of FIGS. 12A-12C and 13. However, in this example the first and second body portions 10b1, 10b2 are biased in abutment with a resilient element 10c which here is formed by a compression spring.

In this example, the retainer 24 is different than in the example of FIGS. 12A-12C and 13. Here, the retainer 24 is formed as a an axially oriented retainer pin. In this example, three retainer pins are provided. The retainer pin 24 is slidably held in a bore in the first body portion 10b1. The second rotatable unit 4 includes a, here three, notch 30. The retainer pin 24 is biased towards the second rotatable unit 4 by a resilient element 28, here a compression spring. A tip of the retainer pin 24 which is directed towards the second rotatable unit 4 here is rounded. The rounded tip can match a shape of the notch 30. The notch 30 further has an angled face 30a. Within a certain angle of relative rotation from a predefined position, the actuation ring will reset its position due to the spring forces and the shape of the groove and top of the retainer pin.

As can be seen in FIGS. 31b, 31e and 31h, when the retractor member 4e1 has knocked the first actuation member 10a1 out of the first partial groove 20a the tip of the retainer pin 24 is on the angled face 30a of the notch 30. Due to the biasing force of the resilient element 28, the tip is pushed along the angled face 30a to the bottom of the notch 30, as can be seen in FIG. 31i. As a result, the third rotatable unit 10 assumes a defined angular position relative to the second rotatable unit 4. Also, the slight angular movement from the situation shown in FIGS. 31b, 31e and 31h, with the actuation member 10a1 just freed from the groove 20, to the situation shown in FIGS. 31c, 31f and 31i, enables that the retractor member 4e1 lifts the actuation member 10a1 away from the groove 20, so that mechanical contact between the actuation member 10a1 and the fourth unit 16 can be avoided.

When the first body portion 10b1 is rotated against the springs(s) 10c, the second body portion 10b2 keeps its position due to the higher force of the springs 28. This enables the second body portion 10b2 to keep its position even when the first body portion 10b1 has to rotate a little with respect to the second body portion 10b2 during a shift.

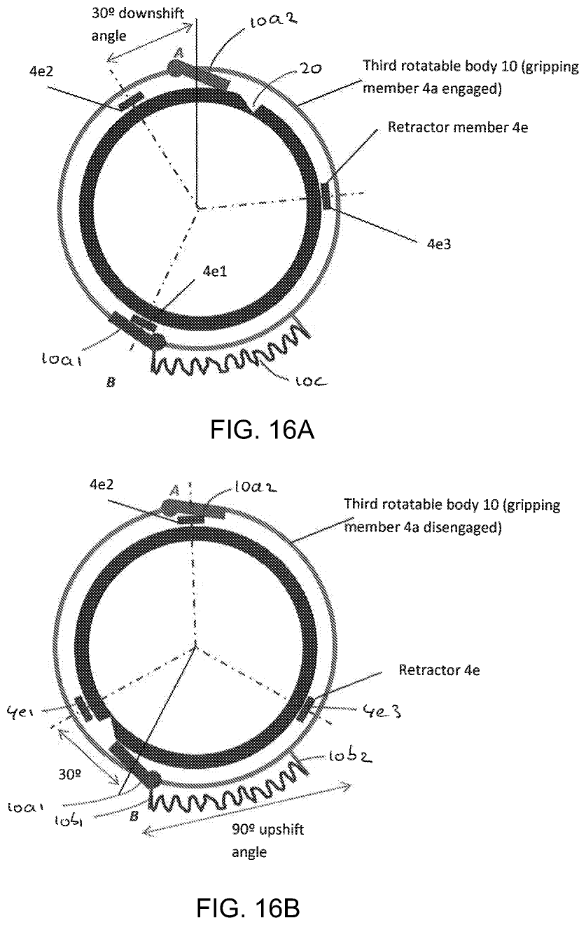

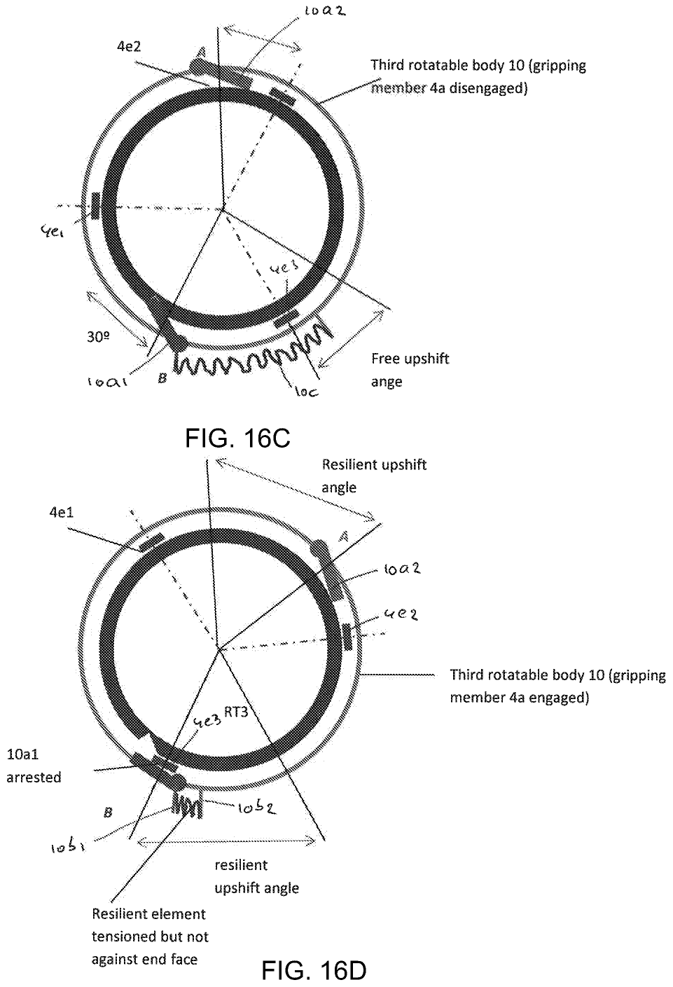

FIGS. 16a-16d show an example of gripping and ungripping the actuation members 10a in the groove 20. In FIG. 16a the first actuation member 10a1 is arrested on the retractor member 4e1. The second actuation member 10a2 is ready for being gripped by the groove 20. In FIG. 16b the second rotatable unit 4 having the retractor members 4e has been rotated over 30 degrees relative to the position in FIG. 16a. In FIG. 16b the second actuation member 10a2 is arrested on the retractor member 4e2. The first actuation member 10a1 is ready for being gripped by the groove 20. In FIG. 16c the first actuation member 10a1 has been gripped by the groove 20. The third rotatable body 10 does not rotate. The retractor member 4e2 slips from under the second actuation member 10a2. The gripping members 4a are not engaged with the first abutment surfaces. The second body portion 10b2 of the third rotatable body 10 is not entrained in rotation over the free upshift angle as no forces act on it. However, continued rotation of the first rotatable unit 2 relative to the third rotatable body 10 causes the gripping members 4a to engage. Then the second body portion 10b2 of the third rotatable body 10 co-rotates with the first rotatable unit 2 in view of the engaged griping members 4a. Then the resilient element 10c is compressed (FIG. 16d) as the first body portion 10b1 of the third rotatable body 10 is still prevented from rotating by the gripped first actuation member 10a1. When the first rotatable unit 2 is driven, the gripping members 4a can automatically disengage. When the first rotatable unit 2 is not driven, engagement of the gripping members 4a can maintain while the first actuation member 10a1 is lift from the groove and the first actuation member is arrested on the retractor 4e3 (forces arresting the first actuation member 10a1 on the retractor 4e3 must thereto be larger than the force of the compressed resilient element 10c). When the gripping members 4a are disengaged (e.g. by driving the first rotatable unit, e.g. by exerting force to the bicycle pedals) the second body portion 10b2 of the third rotatable body 10 is rotated back over the resilient upshift angle while relaxing the resilient member 10c. Herein the gripping members 4a are retained by the retaining members 12. Thus the situation of FIG. 16a is regained.

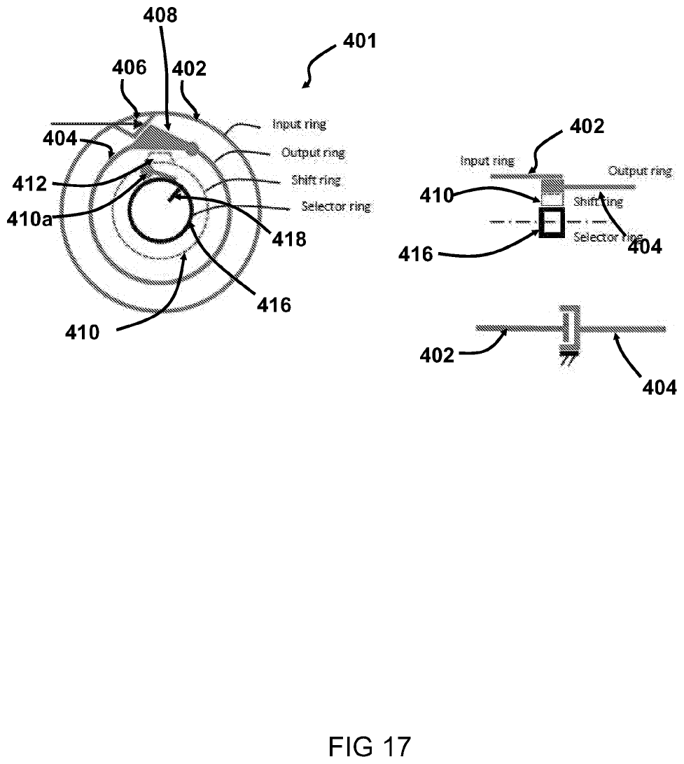

FIG. 17 shows a schematic representation of a clutch or brake system 401. The clutch or brake system 401 can be used as transmission clutch 318, 318A, 318B in the transmission system 300 as described in view of FIGS. 2-8. The clutch or brake system in FIG. 17 includes an, here rotatable, input ring 402. The input ring 402 is arranged to be connected to the input. The input ring 402 can e.g. be embodied as the first unit 2 as described in view of FIGS. 9-15. The clutch or brake system 401 includes an, here rotatable, output ring 404. The output ring 404 is arranged to be connected to the output. The output ring 404 can e.g. be embodied as the second unit 4 as described in view of FIGS. 9-15. The input ring 402 includes at least one first abutment surface 406. The output ring 404 includes at least one second abutment surface 408. The clutch or brake system 401 in FIG. 17 includes a, here rotatable, shift ring 410. The shift ring 410 includes at least one retaining member 412. The shift ring 410 can e.g. be embodied as the third unit 10 as described in view of FIGS. 9-15. The shift ring 410 includes at least one actuation member 410a arranged for moving the shift ring 410 from a first position to a second position or from a second position to a first position relative to the output ring 404. In FIG. 17 the clutch or brake system 401 further includes a, here non-rotatable, selector ring 416. The selector ring 416 can be arranged to be non-rotatably mounted to a frame of the bicycle. The selector ring 416 includes a selector 418. The selector ring 416 can e.g. be embodied as the fourth unit 16 as described in view of FIGS. 9-15.

In the example of FIG. 17, the input ring 402 is on the outside. The shift ring 410 rotates with the output ring 404 and at output speed. The selector ring 416 enables position change of the shift ring 410 relative to the output ring 404. The selector ring 416 is actuated from the fixed world on the inside. When used as a brake, the output ring 404 is preferred to be coupled to the fixed world.

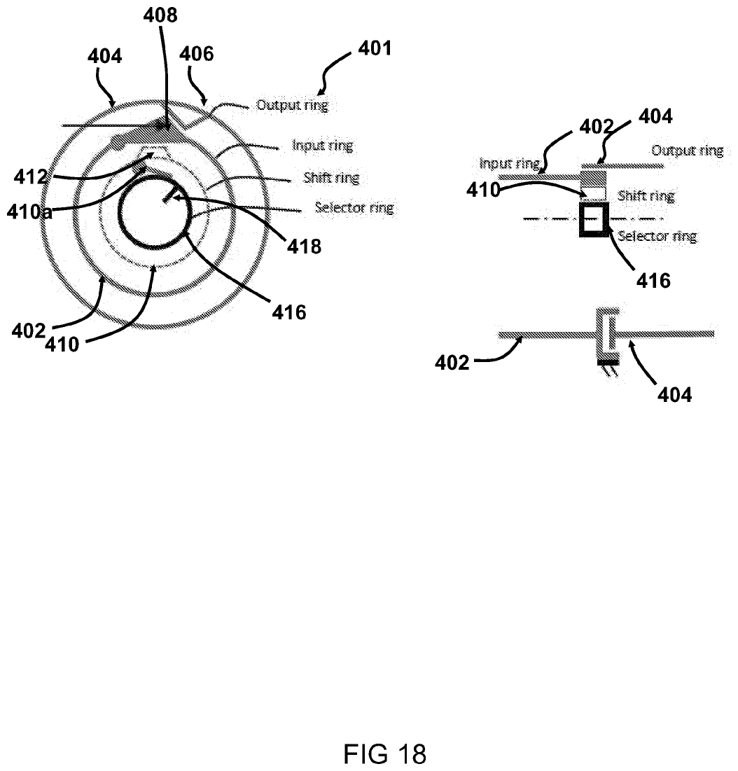

FIG. 18 shows a schematic representation of a clutch or brake system 401. The clutch system 401 can be used as transmission clutch 318, 318A, 318B in the transmission system 300 as described in view of FIGS. 2-8. The clutch or brake system in FIG. 18 includes an, here rotatable, input ring 402. The input ring 402 is arranged to be connected to the input. The input ring 402 can e.g. be embodied as the second unit 4 as described in view of FIGS. 9-15. The clutch or brake system 401 includes an, here rotatable, output ring 404. The output ring 404 is arranged to be connected to the output. The output ring 404 can e.g. be embodied as the first unit 2 as described in view of FIGS. 9-15. The input ring 402 includes at least one first abutment surface 406. The output ring 404 includes at least one second abutment surface 408. The clutch or brake system 401 in FIG. 18 includes a, here rotatable, shift ring 410. The shift ring 410 includes at least one retaining member 412. The shift ring 410 can e.g. be embodied as the third unit 10 as described in view of FIGS. 9-15. The shift ring 410 includes at least one actuation member 410a arranged for moving the shift ring 410 from a first position to a second position or from a second position to a first position relative to the output ring 404. In FIG. 18 the clutch system 401 further includes a, here non-rotatable, selector ring 416. The selector ring 416 can be arranged to be non-rotatably mounted to a frame of the bicycle. The selector ring 416 includes a selector 418. The selector ring 416 can e.g. be embodied as the fourth unit 16 as described in view of FIGS. 9-15.

In the example of FIG. 18, the output ring 404 is on the outside. The shift ring 410 rotates with input ring 402 and at input speed. The selector ring 416 enables position change of the shift ring 410 relative to the input ring 402. The selector ring 416 is actuated from the fixed world on the inside.

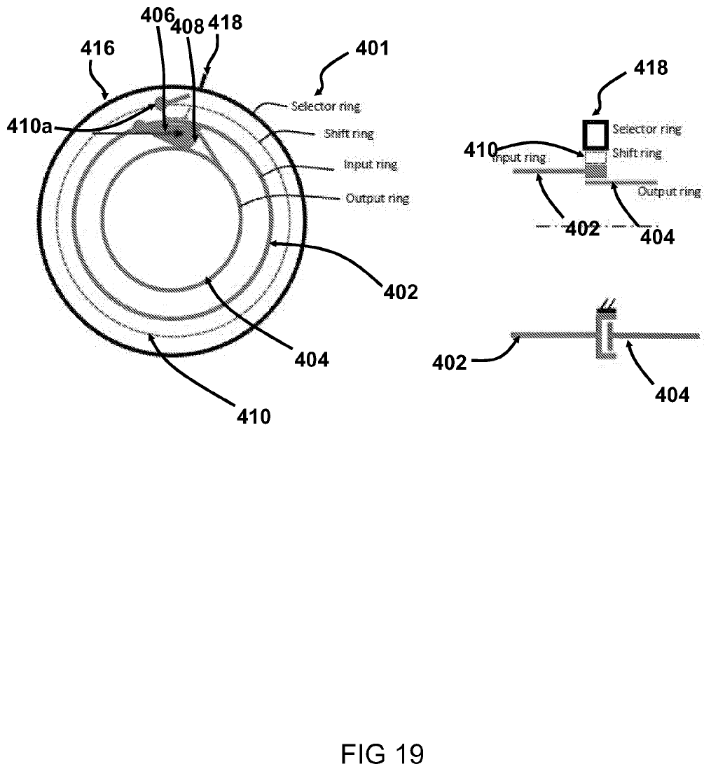

FIG. 19 shows a schematic representation of a clutch or brake system 401. The clutch or brake system 401 can be used as transmission clutch 318, 318A, 318B in the transmission system 300 as described in view of FIGS. 2-8. The clutch or brake system in FIG. 19 includes an, here rotatable, input ring 402. The input ring 402 is arranged to be connected to the input. The clutch or brake system 401 includes an, here rotatable, output ring 404. The output ring 404 is arranged to be connected to the output. The input ring 402 includes at least one first abutment surface 406. The output ring 404 includes at least one second abutment surface 408. The clutch or brake system 401 in FIG. 19 includes a, here rotatable, shift ring 410. The shift ring 410 includes at least one retaining member 412. The shift ring 410 includes at least one actuation member 410a arranged for moving the shift ring 410 from a first position to a second position or from a second position to a first position relative to the output ring 404. In FIG. 19 the clutch brake system 401 further includes a, here non-rotatable, selector ring 416. The selector ring 416 can be arranged to be non-rotatably mounted to a frame of the bicycle. The selector ring 416 includes a selector 418.

In the example of FIG. 19, the output ring 404 is on the inside. Here, the selector ring 416 is on the outside. The shift ring 410 rotates with input ring 402 and at input speed. The selector ring 416 enables position change of the shift ring 410 relative to the input ring 402. The selector ring 416 is actuated from the fixed world on the outside.

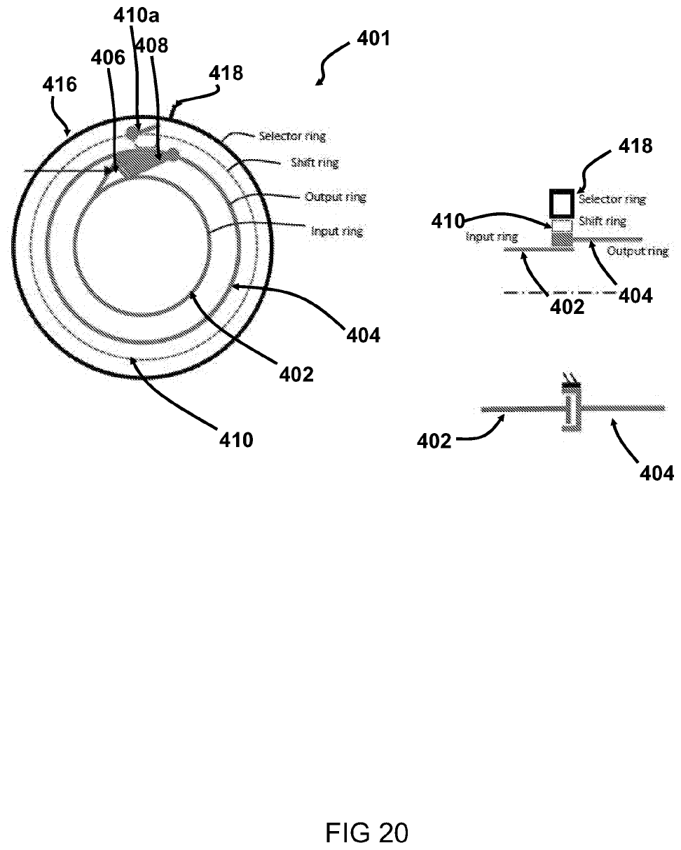

FIG. 20 shows a schematic representation of a clutch or brake system 401. The clutch or brake system 401 can be used as transmission clutch 318, 318A, 318B in the transmission system 300 as described in view of FIGS. 2-8. The clutch system in FIG. 20 includes an, here rotatable, input ring 402. The input ring 402 is arranged to be connected to the input. The clutch or brake system 401 includes an, here rotatable, output ring 404. The output ring 404 is arranged to be connected to the output. The input ring 402 includes at least one first abutment surface 406. The output ring 404 includes at least one second abutment surface 408. The clutch or brake system 401 in FIG. 20 includes a, here rotatable, shift ring 410. The shift ring 410 includes at least one retaining member 412. The shift ring 410 includes at least one actuation member 410a arranged for moving the shift ring 410 from a first position to a second position or from a second position to a first position relative to the output ring 404. In FIG. 20 the clutch or brake system 401 further includes a, here non-rotatable, selector ring 416. The selector ring 416 can be arranged to be non-rotatably mounted to a frame of the bicycle. The selector ring 416 includes a selector 418.

In the example of FIG. 20, the input ring 402 is on the inside. Here, the selector ring 416 is on the outside. The shift ring 410 rotates with the output ring 402 and at output speed. The selector ring 416 enables position change of the shift ring 410 relative to the output ring 404. The selector ring 416 is actuated from the fixed world on the outside. When used as brake, the output ring 404 is preferred to be coupled to the fixed world.

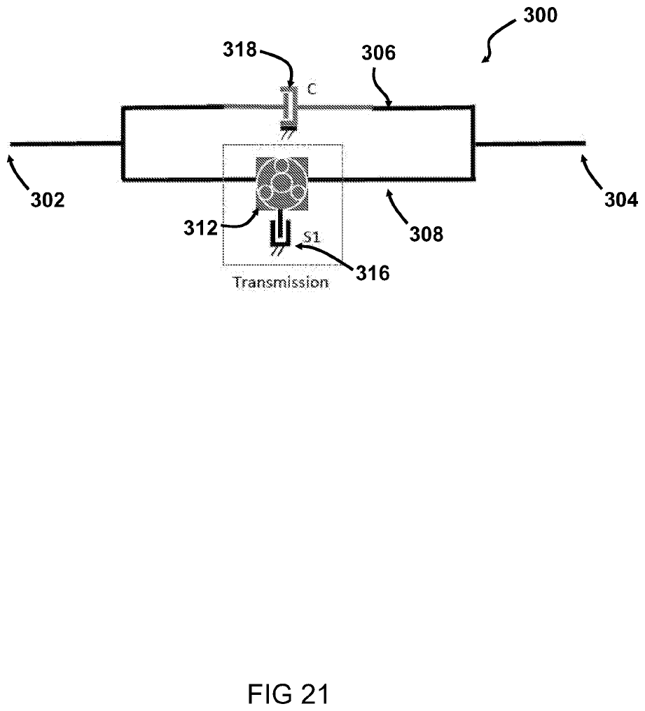

FIG. 21 shows an example of a transmission system 300 similar to the system shown in FIG. 2. In this example, the load-shifting clutch 318 is e.g. embodied as described with respect to FIGS. 9-20. The transmission clutch 316 can be a form-closed clutch, a force-closed clutch, a freewheel, a ratchet, a one-way bearing, or the like. Here the transmission 312 forms a reduction gear between the input and the output.

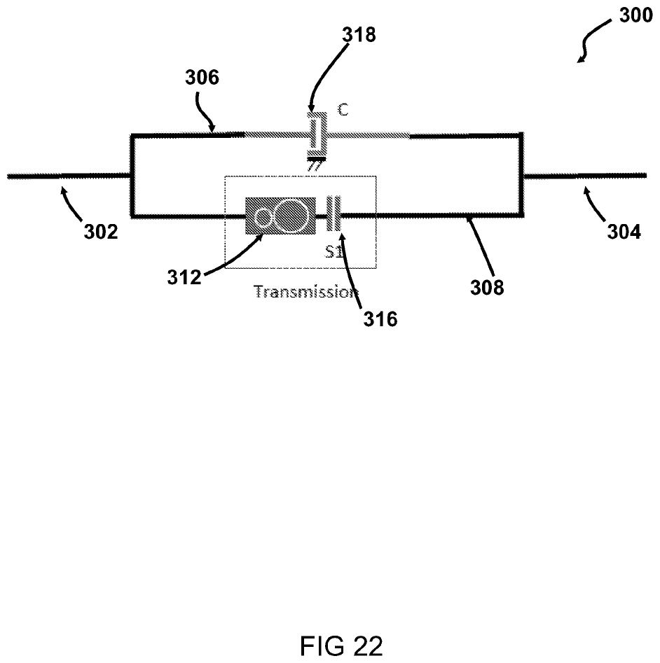

FIG. 22 shows an example of a transmission system 300 including a the load-shifting clutch 318, e.g. as embodied as described with respect to FIGS. 9-20 in the first transmission path 306. The second transmission path 308 includes a second transmission 312 and a transmission clutch 316. The transmission clutch 316 can be a form-closed clutch, a force-closed clutch, a freewheel, a ratchet, a one-way bearing, or the like. Here the transmission 312 forms a reduction gear between the input and the output.

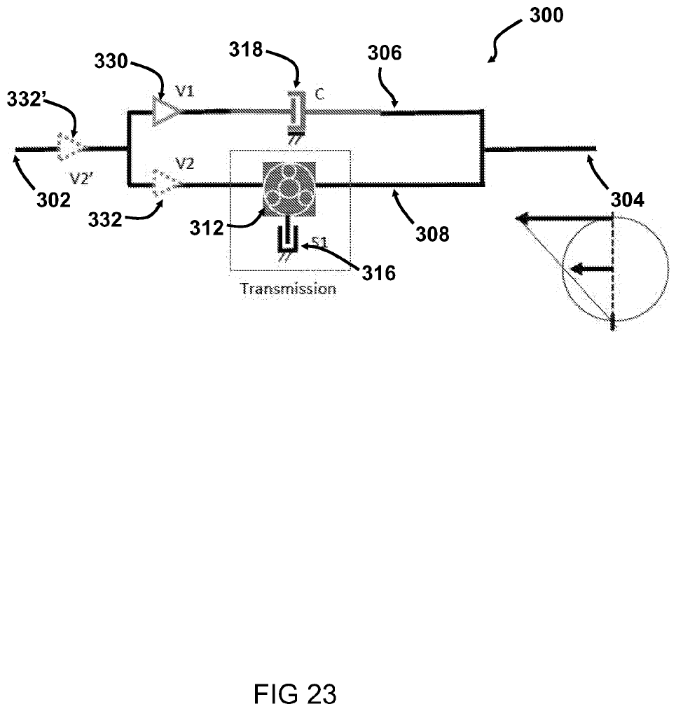

FIG. 23 shows an example of a transmission system 300 similar to the system shown in FIG. 21. Here, the first transmission path further includes a first one-way coupling 330 between the input 302 of the transmission and an input of the load-shifting clutch 318. The first one-way coupling 330 enables freewheeling of the input 302 and anti-lock up when the output 304 reverses in rotation direction (transmission input speed increase when clutch 318 is closed). Optionally a second one-way coupling 332 is included in the second transmission path 308. Alternatively a second one way coupling 332′ can be included at the input 302. It will be appreciated that if the transmission clutch 316 is a freewheel, the second one-way coupling 332, 332′ can be omitted. Here the transmission 312 forms a reduction gear between the input and the output.

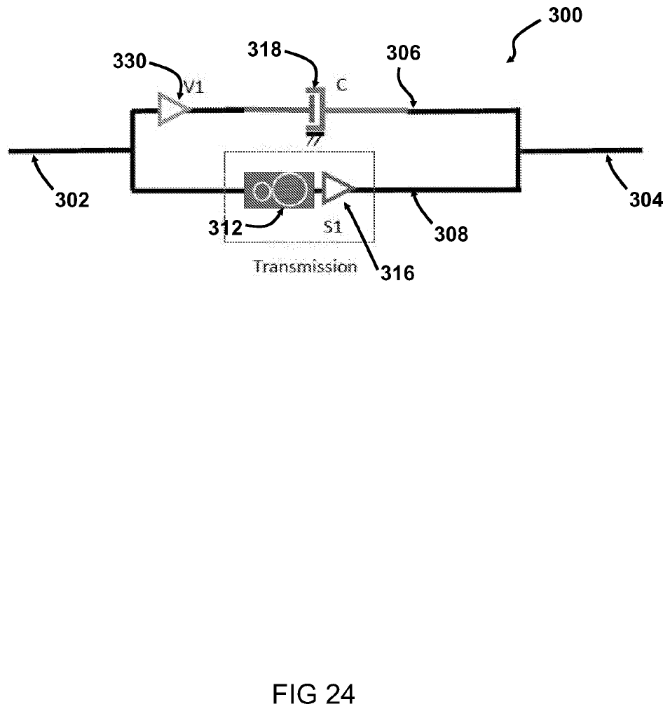

FIG. 24 shows an example of a transmission system 300 similar to the system shown in FIG. 22. Here, the first transmission path further includes a first one-way coupling 330 between the input 302 of the transmission and an input of the load-shifting clutch 318. The first one-way coupling 330 enables freewheeling of the input 302 and anti-lock up when the output 304 reverses in rotation direction (transmission input speed increase when clutch 318 is closed). In this example, the transmission clutch 316 is a one-way coupling, such as a freewheel. Here the transmission 312 forms a reduction gear between the input and the output.

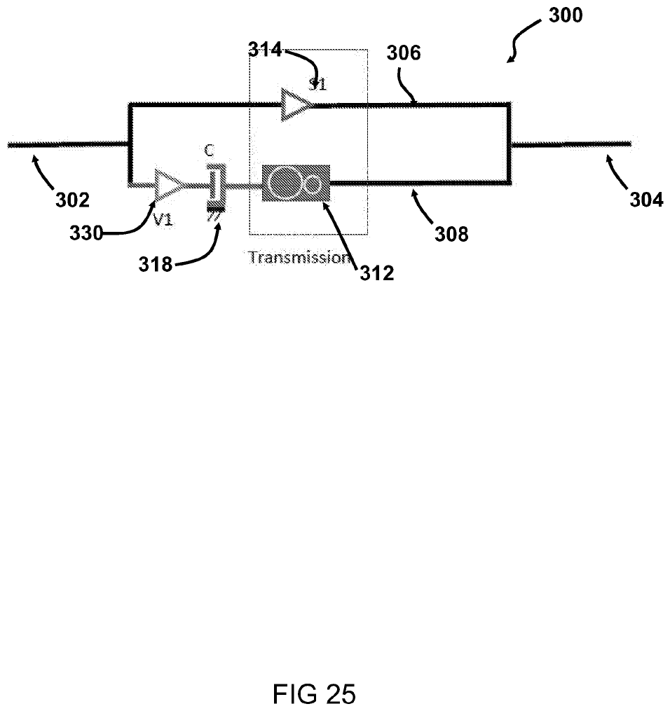

FIG. 25 shows an example of a transmission system 300. Here, the first transmission path includes a transmission clutch 314 embodied as a one-way coupling, such as a freewheel. The second transmission path 308 includes a one-way coupling 330, a load-shifting clutch 318 and a transmission 312. Here the transmission 312 forms a speed-up gear between the input and the output.

It will be appreciated that the transmission 312, 314, 312A, 312B, 314A, 314B can be any combination of gears, planetary gear sets, belts, chains, and also multiple gears in series or in parallel.

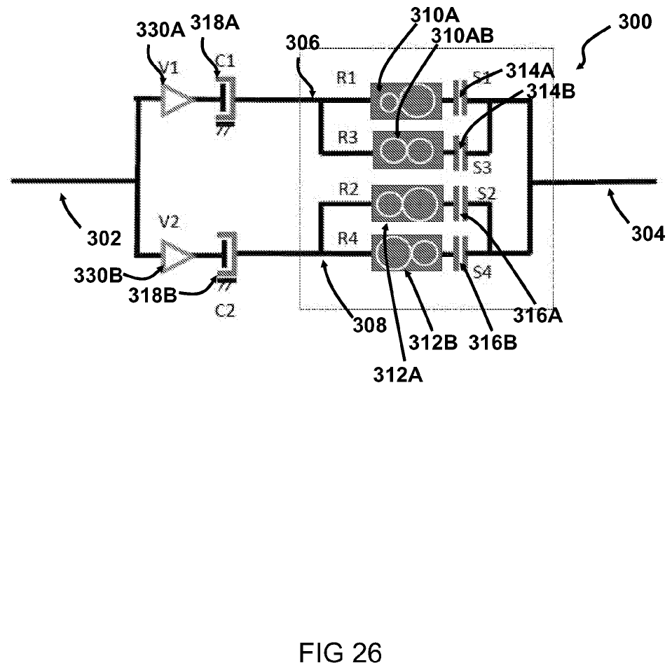

FIG. 26 shows an example of a transmission system 300, such as for a two wheeled bicycle, similar to the system of FIG. 4. Features in common with the system 300 as described in view of FIG. 4 will not be discussed in detail. In this example load-shifting clutches 318A, 318B are embodied as described with respect to FIGS. 9-20. The first and second transmission paths 306, 308 further include one-way couplings 330A, 330B.

In this example, the transmission clutches 314A and 316A are the transmission clutches on the lowest gears and can be embodied by a passive freewheel or one-way bearing. Table I below shows ab exemplary action list for shifting up and/or down. The column headed “Ratio” indicates which transmission ratio is active, and which transmission ratio is pre-selected. The columns V1-S4 indicate the state of the respective clutches (see FIG. 26), in which “x” indicates coupled, and “0” indicates decoupled.

TABLE I

| Ratio | upshift | V1 | C1 | V2 | C2 | S1 | S2 | S3 | S4 | downshift |
|---|---|---|---|---|---|---|---|---|---|---|
| R1 + R2 | Close C2 | x | x | 0 | 0 | x | x | 0 | 0 | |
| pre- | | | | | | | | | | |
| selected | | | | | | | | | | |
| R2 + R1 | Open C1, | 0 | x | x | x | x | x | 0 | 0 | Open C2 |
| pre- | open S1 and | | | | | | | | | |
| selected | close S3 | | | | | | | | | |
| R2 + R3 | Close C1 | 0 | 0 | x | x | 0 | x | x | 0 | open S3 and |
| pre- | | | | | | | | | | close S1 and |
| selected | | | | | | | | | | Close C1 |
| R3 + R2 | Open C2, | x | x | 0 | x | 0 | x | x | 0 | Open C1 |
| pre- | open S2 and | | | | | | | | | |
| selected | close S4 | | | | | | | | | |
| R3 + R4 | Close C2 | x | x | 0 | 0 | 0 | 0 | x | x | open S4 and |
| pre- | | | | | | | | | | close S2 and |
| selected | | | | | | | | | | Close C2 |
| R4 + R3 | | x | x | x | x | 0 | 0 | x | x | Open C2 |
| pre- | | | | | | | | | | |
| selected | | | | | | | | | | |

In order to create rotation of the output of the load-shifting clutches 318A and 318B, the transmission clutches 314B and 316B are embodied as claw (form closed bidirectional) clutches so that the output of the load-shifting clutches 318A and 318B are driven by the output of the system, e.g. by the wheel of the bicycle. The load-shifting clutches 318A and 318B can be reversed in order to shift based on input speed.

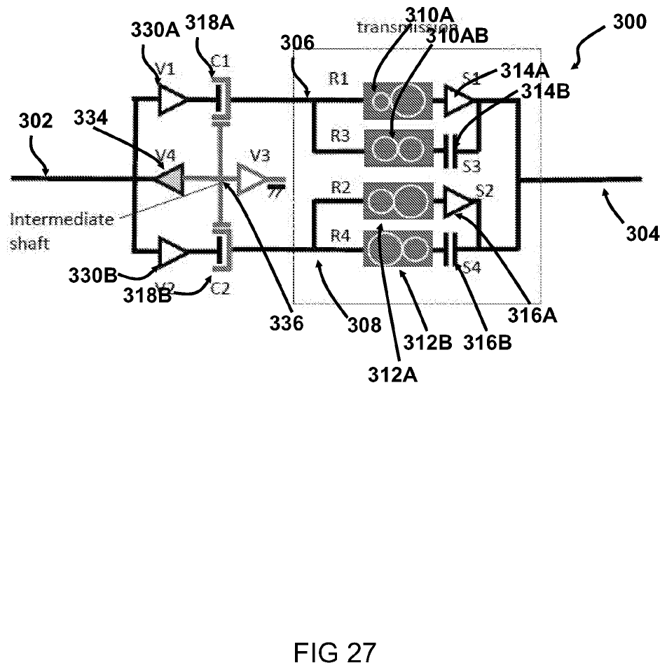

FIG. 27 shows an example of a transmission system 300, such as for a two wheeled bicycle, similar to the system of FIG. 26. Features in common with the system 300 as described in view of FIG. 26 will not be discussed in detail. In this example, a further one-way coupling 334 is included, driving an intermediate shaft 336. The further one-way coupling 334 drives the intermediate shaft 336 backwards with input shaft rotating counter clockwise (reverse). This enables shift execution at stand-still. The selector rings and actuators have to rotate in this case, which can be difficult with wiring to electric motors. Therefore a rotation angle of the intermediate shaft could be limited to 90 degrees, to enable the shift but limit wire movement.

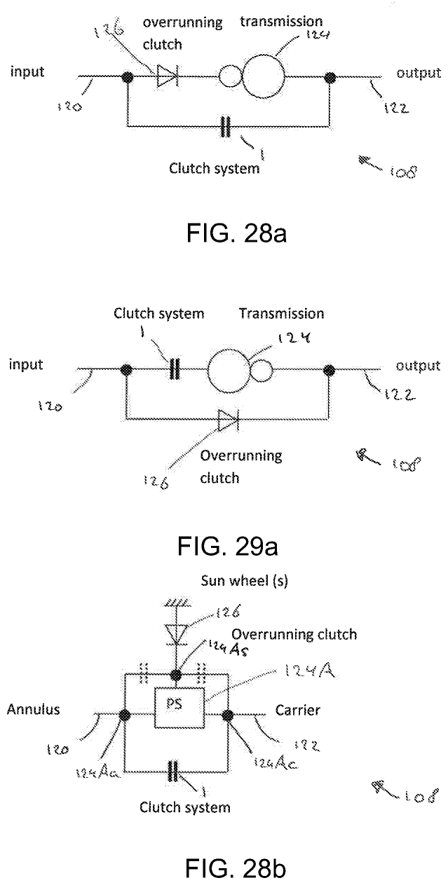

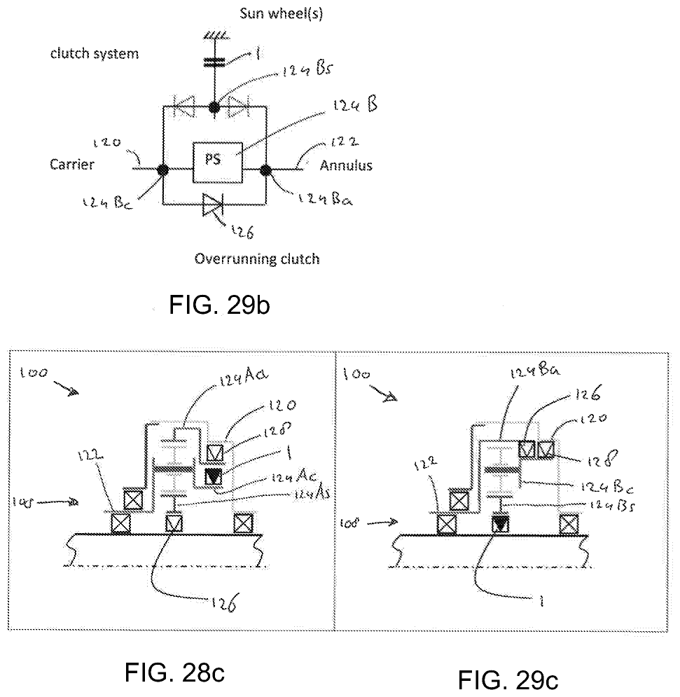

FIG. 28a shows a schematic example of a torque transmission 108. The torque transmission 108 includes an input 120 and an output 122. The torque transmission 108 includes a gear transmission 124. Here the gear transmission 124 is a reduction for converting a rotational speed at the input 120 to a reduced rotational speed at the output 122. The torque transmission also includes a clutch system 1, e.g. as described in view of FIGS. 9-15. The gear transmission 124 is selectably included in the torque transmission 108. The torque transmission is arranged for, in a first mode, transmitting the rotational speed at the input 120 unchanged to the output 122, when the clutch system 1 is engaged. The torque transmission is arranged for, in a second mode, transmitting the rotational speed at the input 120 reduced to the output 122, when the clutch system 1 is disengaged. An overrunning clutch 126 is included, in this example in series with the gear transmission 124.

FIG. 29a shows a schematic example of a torque transmission 108. The torque transmission 108 includes an input 120 and an output 122. The torque transmission 108 includes a gear transmission 124. Here the gear transmission 124 is a arranged for converting a rotational speed at the input 120 to an increased rotational speed at the output 122. The torque transmission also includes a clutch system 1, e.g. as described in view of FIGS. 9-15. The gear transmission 124 is selectably included in the torque transmission 108. The torque transmission is arranged for, in a first mode, transmitting the rotational speed at the input 120 unchanged to the output 122, when the clutch system 1 is disengaged. The torque transmission is arranged for, in a second mode, transmitting the rotational speed at the input 120 increased to the output 122, when the clutch system 1 is engaged. An overrunning clutch 126 is included, in this example in parallel with the gear transmission 124.

FIG. 28b shows a schematic example of a torque transmission 108. The torque transmission 108 includes an input 120 and an output 122. The torque transmission 108 includes a gear transmission 124. Here the gear transmission 124 is a planetary gear system 124A for converting a rotational speed at the input 120 to a reduced rotational speed at the output 122. In this example, the input 120 is connected to the annulus 124Aa of the planetary gear system 124A. Here, the output 122 is connected to the carrier 124Ac of the planetary gear system 124A. The torque transmission also includes a clutch system 1, e.g. as described in view of FIGS. 9-15, here included selectively connecting the annulus and the carrier. The sun wheel 124As of the planetary gear system 124A is connected to a non-rotary part via the overrunning clutch 126. The torque transmission is arranged for, in a first mode, transmitting the rotational speed at the input 120 unchanged to the output 122, when the clutch system 1 is engaged. The torque transmission is arranged for, in a second mode, transmitting the rotational speed at the input 120 reduced to the output 122, when the clutch system 1 is disengaged. Decoupling of the overrunning clutch 126 may be required for allowing the output 122 in reverse direction. An input overrunning clutch 128 may be required for freewheeling, e.g. while driving without pedaling.

FIG. 28c shows a schematic cross section of a torque transmission 108 according to FIG. 28b in an axle assembly 100, such as a bicycle rear wheel assembly.

FIG. 29b shows a schematic example of a torque transmission 108. The torque transmission 108 includes an input 120 and an output 122. The torque transmission 108 includes a gear transmission 124. Here the gear transmission 124 is a planetary gear system 124B for converting a rotational speed at the input 120 to an increased rotational speed at the output 122. In this example, the input 120 is connected to the carrier 124Bc of the planetary gear system 124B. Here, the output 122 is connected to the annulus 124Ba of the planetary gear system 124B. The torque transmission also includes a clutch system 1, e.g. as described in view of FIGS. 9-15, here included selectively connecting the sun wheel 124Bs of the planetary gear system 124B to a non-rotary part. The carrier is connected to the annulus via an overrunning clutch 126. The torque transmission is arranged for, in a first mode, transmitting the rotational speed at the input 120 unchanged to the output 122, when the clutch system 1 is disengaged. The torque transmission is arranged for, in a second mode, transmitting the rotational speed at the input 120 reduced to the output 122, when the clutch system 1 is engaged. Decoupling of the overrunning clutch 126 may be required for allowing the output 122 in reverse direction. An input overrunning clutch 128 may be required for freewheeling, e.g. while driving without pedaling.

FIG. 29c shows a schematic cross section of a torque transmission 108 according to FIG. 29b in an axle assembly 100, such as a bicycle rear wheel assembly.

FIG. 30 shows an example of an axle assembly 100. In this example, the axle assembly is a rear bicycle assembly. The axle assembly 100 here includes a hollow axle 101. In this example, the hollow axle 101 is arranged for non-rotatably being fixed to a frame, e.g. a bicycle frame. In this example the axle assembly is an axle assembly for a bicycle. The axle assembly 100 includes a hub 102. Here the hub 102 is provided with apertures 104, e.g. for connection of spokes of a wheel, The axle assembly 100 further includes a driver 106. The driver 106 in this example is arranged for receiving a cassette of gear wheels 107 (not shown in FIG. 30), e.g. via a splined connection.

The axle assembly 100 in this example includes a torque transmission 108. In this example, the torque transmission 108 is positioned inside the driver 106. Here the torque transmission includes a clutch system 1, e.g. as described in view of FIGS. 9-15, and a gear means, here a planetary gear 110, The planetary gear 110 includes a sun gear 112, a planet carrier 114 with planet gears 116 and a ring gear 118. The clutch system 1 is arranged in the torque transmission 108 so as to selectively couple two of the sun gear, the planet carrier and the ring gear. In this example, In this example, the clutch system 1 is arranged in the torque transmission 108 so as to selectively couple the planet carrier 114 and the ring gear 118.

The planet carrier 114 is also fixedly coupled to the hub 102. Therefore, depending on whether the first rotatable unit 2 and second rotatable unit 4 are rotationally coupled, or rotationally disengaged, driving the driver 106 causes the hub 102 to rotate according to a first or second gear ratio relative to the driver 106. An overrunning clutch 111 may thereto be positioned between the sun gear 112 and the axle 101. In the examples of FIGS. 9-20, the first rotatable unit 2, the second rotatable unit 4, the third rotatable unit 10, and the fourth unit 16 are coaxial. Here, the fourth unit 16 is positioned at least partially within the third rotatable unit 10. Here the third rotatable unit 10 is at least partially positioned within the second rotatable unit 4. Here the second rotatable unit 4 is at least partially positioned within the first rotatable unit 2.

In the example of FIG. 30 the torque transmission 108 is positioned inside the driver 106. It will be appreciated that the torque transmission can also be a torque transmission according to any of FIGS. 28a-29c. It is also possible that the torque transmission is formed as a transmission system 300 according to any of FIG. 2-8 or 21-27, and is positioned, e.g. partially, inside the driver 106, similarly to shown in FIG. 30. In that case the input 302 can be connected to the driver 106, and the output 304 can be connected to the wheel hub 102. The input 302 can be rigidly connected to, e.g. formed by, the driver 106. The input 302 can be connected to the driver 106 via a freewheel clutch. The output 304 can be rigidly connected to, e.g. formed by, the wheel hub 102. The output 304 can be connected to the wheel hub 102 via a splined connection.

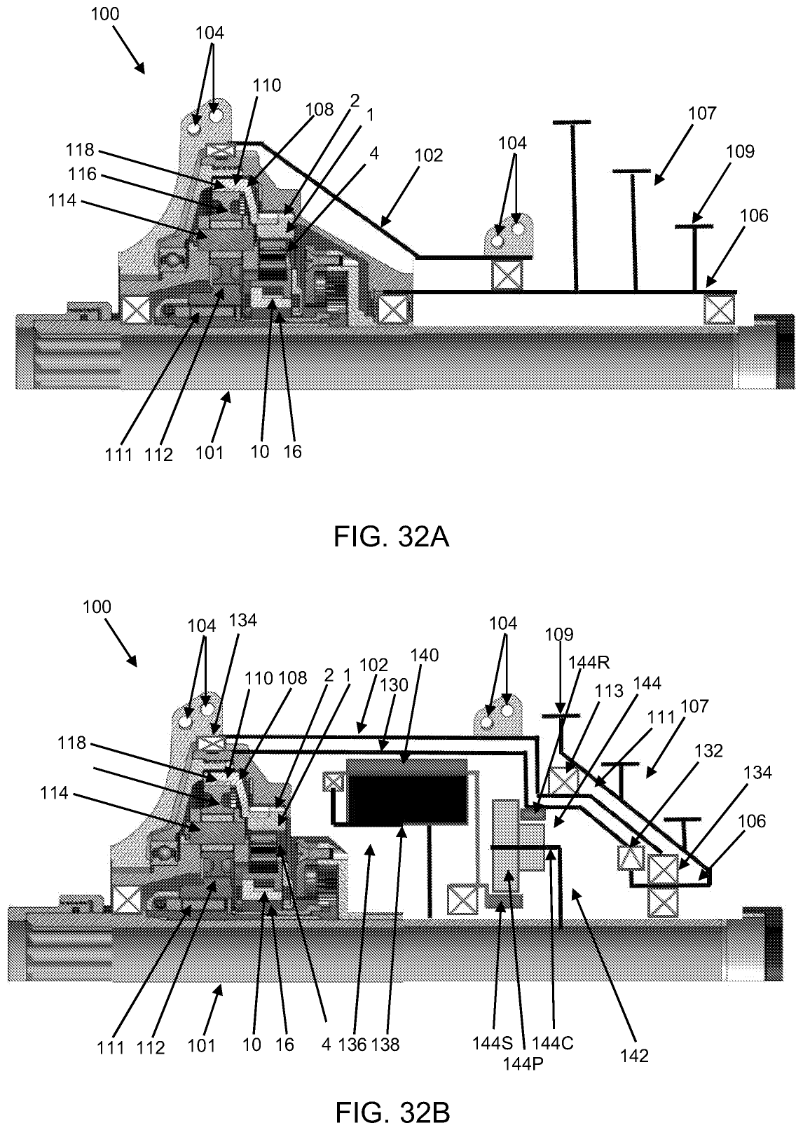

FIG. 32A shows an example of an axle assembly 100. The axle assembly 100 of FIG. 32A is similar to the axle assembly of FIG. 30. A difference is that in the example of FIG. 32A the torque transmission 108 is positioned inside the wheel hub 102. In this case the driver 106 can be a splined driver, e.g. having a constant cross section along its axial length. The torque transmission 108 in this example is as described in relation to FIG. 30, however it will be appreciated that the torque transmission 108 can also be a torque transmission according to any of FIGS. 28a-29c. It is also possible that the torque transmission is formed as a transmission system 300 according to any of FIG. 2-8 or 21-27, and is positioned inside the wheel hub 102, similarly to shown in FIG. 32A. In that case the input 302 can be connected to the driver 106, and the output 304 can be connected to the wheel hub 102. The input 302 can be rigidly connected to, e.g. formed by, the driver 106. The input 302 can be connected to the driver 106 via a freewheel clutch. The output 304 can be rigidly connected to, e.g. formed by, the wheel hub 102. The output 304 can be connected to the wheel hub 102 via a splined connection.

FIG. 32B shows an example of an axle assembly 100. The axle assembly 100 of FIG. 32B is similar to the axle assembly of FIG. 32A. A difference is that in the example of FIG. 32B an electric motor 136 is positioned inside the wheel hub 102. The torque transmission 108 in this example is as described in relation to FIG. 30, however it will be appreciated that the torque transmission can also be a torque transmission according to any of FIGS. 28a-29c. It is also possible that the torque transmission is formed as a transmission system 300 according to any of FIG. 2-8 or 21-27, and is positioned inside the wheel hub 102, similarly to shown in FIG. 32B. In that case the input 302 can be connected to the driver 106, and the output 304 can be connected to the wheel hub 102, as explained in relation to FIG. 32A.

In the example of FIG. 32B the driver 106 is connected to an intermediate drive part 130, here via a freewheel clutch 132, for driving the intermediate drive part 13 in rotation. In this example, the intermediate drive part 130 forms an inner shell, rotatably housed inside the hub 106. Here, the hub 106 is rotatable mounted to an outer side of the intermediate drive part 130 via bearings 134. In this example, the cassette 107 comprises a plurality of sprockets 109. Here, the cassette 107 has a tapered central axial opening 111. The tapered central axial opening 111 has a larger diameter at larger sprockets and a smaller diameter at smaller sprockets. Here, the wheel hub 102 extends into the tapered central axial opening 111. Hence, the wheel hub 102 is positioned, at least partially, radially inside the cassette 107. In this example, also the intermediate drive part 130 is positioned, at least partially, radially inside the cassette 107. The cassette 107 is supported on the wheel hub 102 via a bearing 113. It will be appreciated that in this example, the cassette 107 transfers torque to the driver 106 at a distal end of the cassette 107, axially away from a center of the wheel axle assembly 100. Thus, the cassette 107 transmits torque to the driver 106 on a diameter that is smaller than a diameter of a smallest sprocket 109 of the cassette 107. Here, the cassette 107 transmits torque to the driver 106 on a diameter that is smaller than or equal to an inner diameter of the smallest sprocket of the cassette. Also in this example, the driver 106 transmits torque to the intermediate drive part 130 on a diameter that is smaller than or equal to an inner diameter of the smallest sprocket 109 of the cassette 107.

FIG. 32B further shows the electric motor 136. In this example the stator 138 of the electric motor 136 is positioned concentrically inside the rotor 140 of the electric motor 136. The stator 138 is rigidly connected to the axle 101. The axle 101 is configured to be attached to a frame of the bicycle, such that the axle 101 does not rotate relative to the frame. In this example, the axle 101 is a hollow axle. Hence, the stator 138 is immobile relative to the frame. The rotor 140 is connected to the intermediate drive part 130 via a motor transmission 142 to drive the intermediate drive part 130 in rotation. In this example, the motor transmission 142 is a planetary gear set 144. Here, the rotor 140 drives the sun gear 144S of the planetary gear set 144. The planet carrier 144C is rigidly connected to the axle 101. In this example, the planet carrier 144C carries planet gears 144P of two sizes. The ring gear 144R is coupled to the intermediate drive part 130. Hence, the planetary gear set 144 forms a reducing transmission ratio from the rotor 140 to the intermediate drive part 130. It will be appreciated that the motor transmission 142 can directly rigidly couple to the intermediate drive part 130, or via a freewheel clutch.

In the example of FIG. 32B the electric motor 136 drives the intermediate drive part 130, which in turn drives the torque transmission 108 (or transmission system 300), which in turn drives the wheel hub 102. It will be appreciated that it is also possible that the electric motor 136 drives the wheel hub 102 directly, or via the motor transmission 142. Thus, the motor torque can be transmitted to the wheel hub 102 while not passing through the torque transmission 108 (or transmission system 300).

The electric motor 136 can be configured, e.g. by a controller, to act as motor for providing assistance during riding. It is also possible that the electric motor 136 is configured, e.g. by a controller, to act as a generator. The electric motor 136 acting as generator can be used for charging a battery of the bicycle. The electric motor 136 acting as generator can also be used for providing additional resistance against rotation to the wheel hub, e.g. for training purposes.

The clutch system 1 can e.g. be used for selectively operating a planetary gear according to a first mode when the second rotatable unit is engaged with the first rotatable unit, and according to a second mode when the second rotatable unit is disengaged from the first rotatable unit. Hence, the clutch system 1 can be used in a torque transmission for operating the torque transmission at a first transmission ratio in the first mode, and at a second, different transmission ratio in the second mode. The clutch system can e.g. be used in a rear hub of a bicycle. The clutch system can then be used e.g. for emulating the functioning of a front derailleur, so as to be able to omit the front derailleur from the bicycle. The invention also relates to a bicycle including such clutch system.

Herein, the invention is described with reference to specific examples of embodiments of the invention. It will, however, be evident that various modifications and changes may be made therein, without departing from the essence of the invention. For the purpose of clarity and a concise description features are described herein as part of the same or separate examples or embodiments, however, alternative embodiments having combinations of all or some of the features described in these separate embodiments are also envisaged.

In the examples, the first rotatable unit includes nine first abutment surfaces. It will be appreciated that other numbers of first abutment surfaces, such as one, two, three, four, six or any other suitable number are also possible. In the examples, the second rotatable unit includes three second abutment surfaces. It will be appreciated that other numbers of second abutment surfaces, such as one, two, four, six or any other suitable number are also possible. In the examples, the third rotatable unit includes three retaining members. It will be appreciated that other numbers of retaining members, such as one, two, four, six or any other suitable number are also possible. In the examples, the third rotatable unit includes two actuation members. It will be appreciated that other numbers of actuation members, such as one, three, four, six or any other suitable number are also possible.

In the examples, the gripping members are separate items hingedly connected to the body portion of the second rotatable unit. It will be appreciated that it is also possible that the gripping members are integral with the body portion of the second rotatable unit.

In the examples, the third rotatable unit includes an first body portion and a second body portion. It will be appreciated that the first and second body portions may also be an integral portion.

In the examples, the actuation members are separate items hingedly connected to the body portion of the third rotatable unit. It will de appreciated that it is also possible that the actuation members are integral with the body portion of the third rotatable unit.

In the examples, the gripping members are arranged for pivoting in a radial direction. It will be appreciated that it is also possible that the gripping members are arranged for pivoting in an axial direction. Then e.g. the second rotatable unit and the first rotatable unit can be positioned, at least partially, axially next to each other. Also, then the third rotatable unit and the second rotatable unit can be positions, at least partially, axially next to each other.

In the examples, the actuation members are arranged for pivoting in a radial direction. It will be appreciated that it is also possible that the actuation members are arranged for pivoting in an axial direction. Then e.g. the third rotatable unit and the fourth unit can be positioned, at least partially, axially next to each other.

In the examples, the first unit, second unit, third unit, and fourth unit are positioned concentrically. It will be appreciated that one or more of the units may also be placed axially next to each other. In the examples, the input ring, output ring, shift ring, and selector ring are positioned concentrically. It will be appreciated that one or more of the rings may also be placed axially next to each other.

Hence, it is also envisaged that:

a) the first unit is connectable to the input, the second unit is connectable to the output, the second unit is arranged at least partially coaxially inside the first unit, the third unit is arranged at least partially coaxially inside the second unit, and the fourth unit is arranged at least partially coaxially inside the third unit;
b) the first unit is connectable to the output, the second unit is connectable to the input, the second unit is arranged at least partially coaxially inside the first unit, the third unit is arranged at least partially coaxially inside the second unit, and the fourth unit is arranged at least partially coaxially inside the third unit;
c) the first unit is connectable to the output, the second unit is connectable to the input, the first unit is arranged at least partially coaxially inside the second unit, the second unit is arranged at least partially coaxially inside the third unit, and the third unit is arranged at least partially coaxially inside the fourth unit;
d) the first unit is connectable to the input, the second unit is connectable to the output, the first unit is arranged at least partially coaxially inside the second unit, the second unit is arranged at least partially coaxially inside the third unit, and the third unit is arranged at least partially coaxially inside the fourth unit;
e) the first unit is connectable to the input, the second unit is connectable to the output, the second unit is arranged at least partially axially beside the first unit, the third unit is arranged at least partially axially beside the first unit or the second unit, and the fourth unit is arranged at least partially axially beside the third unit;
f) the first unit is connectable to the output, the second unit is connectable to the input, the second unit is arranged at least partially axially beside the first unit, the third unit is arranged at least partially axially beside the first unit or the second unit, and the fourth unit is arranged at least partially axially beside the third unit;
g) the first unit is connectable to the input, the second unit is connectable to the output, the second unit is arranged at least partially coaxially inside the first unit, the third unit is arranged at least partially axially beside the first and/or second unit and the fourth unit is arranged at least partially axially beside the third unit;
h) the first unit is connectable to the output, the second unit is connectable to the input, the second unit is arranged at least partially coaxially inside the first unit, the third unit is arranged at least partially axially beside the first and/or second unit, and the fourth unit is arranged at least partially axially beside the third unit;
i) the first unit is connectable to the input, the second unit is connectable to the output, the second unit is arranged at least partially coaxially inside the first unit, the third unit is arranged at least partially axially beside the first and/or second unit and the fourth unit is arranged at least partially coaxially inside and/or outside the third unit;
j) the first unit is connectable to the output, the second unit is connectable to the input, the second unit is arranged at least partially coaxially inside the first unit, the third unit is arranged at least partially axially beside the first and/or second unit, and the fourth unit is arranged at least partially coaxially inside and/or outside the third unit;
k) the first unit is connectable to the input, the second unit is connectable to the output, the first unit is arranged at least partially coaxially inside the second unit, the third unit is arranged at least partially axially beside the first and/or second unit, and the fourth unit is arranged at least partially axially beside the third unit;
l) the first unit is connectable to the output, the second unit is connectable to the input, the first unit is arranged at least partially coaxially inside the second unit, the third unit is arranged at least partially axially beside the first and/or second unit, and the fourth unit is arranged at least partially axially beside the third unit;
m) the first unit is connectable to the input, the second unit is connectable to the output, the first unit is arranged at least partially coaxially inside the second unit, the third unit is arranged at least partially axially beside the first and/or second unit, and the fourth unit is arranged at least partially coaxially inside and/or outside the third unit;
n) the first unit is connectable to the output, the second unit is connectable to the input, the first unit is arranged at least partially coaxially inside the second unit, the third unit is arranged at least partially axially beside the first and/or second unit, and the fourth unit is arranged at least partially coaxially inside and/or outside the third unit;
o) the first unit is connectable to the input, the second unit is connectable to the output, the second unit is arranged at least partially axially beside the first unit, the third unit is arranged at least partially coaxially inside the first and/or second unit, and the fourth unit is arranged at least partially coaxially inside the third unit;
p) the first unit is connectable to the input, the second unit is connectable to the output, the second unit is arranged at least partially axially beside the first unit, the third unit is arranged at least partially coaxially inside the first and/or second unit, and the fourth unit is arranged at least partially coaxially inside the third unit;
q) the first unit is connectable to the input, the second unit is connectable to the output, the second unit is arranged at least partially axially beside the first unit, the third unit is arranged at least partially coaxially inside the first and/or second unit, and the fourth unit is arranged at least partially axially beside the third unit;
r) the first unit is connectable to the input, the second unit is connectable to the output, the second unit is arranged at least partially axially beside the first unit, the third unit is arranged at least partially coaxially inside the first and/or second unit, and the fourth unit is arranged at least partially axially beside the third unit;
s) the first unit is connectable to the input, the second unit is connectable to the output, the second unit is arranged at least partially axially beside the first unit, the third unit is arranged at least partially coaxially around the first and/or second unit, and the fourth unit is arranged at least partially coaxially around the third unit;
t) the first unit is connectable to the input, the second unit is connectable to the output, the second unit is arranged at least partially axially beside the first unit, the third unit is arranged at least partially coaxially around the first and/or second unit, and the fourth unit is arranged at least partially coaxially around the third unit;
u) the first unit is connectable to the input, the second unit is connectable to the output, the second unit is arranged at least partially axially beside the first unit, the third unit is arranged at least partially coaxially around the first and/or second unit, and the fourth unit is arranged at least partially axially beside the third unit; or
v) the first unit is connectable to the input, the second unit is connectable to the output, the second unit is arranged at least partially axially beside the first unit, the third unit is arranged at least partially coaxially around the first and/or second unit, and the fourth unit is arranged at least partially axially beside the third unit

Herein, the invention is described with reference to specific examples of embodiments of the invention. It will, however, be evident that various modifications, variations, alternatives and changes may be made therein, without departing from the essence of the invention. For the purpose of clarity and a concise description features are described herein as part of the same or separate embodiments, however, alternative embodiments having combinations of all or some of the features described in these separate embodiments are also envisaged and understood to fall within the framework of the invention as outlined by the claims. The specifications, figures and examples are, accordingly, to be regarded in an illustrative sense rather than in a restrictive sense. The invention is intended to embrace all alternatives, modifications and variations which fall within the spirit and scope of the appended claims. Further, many of the elements that are described are functional entities that may be implemented as discrete or distributed components or in conjunction with other components, in any suitable combination and location.

In the claims, any reference signs placed between parentheses shall not be construed as limiting the claim. The word ‘comprising’ does not exclude the presence of other features or steps than those listed in a claim. Furthermore, the words ‘a’ and ‘an’ shall not be construed as limited to ‘only one’, but instead are used to mean ‘at least one’, and do not exclude a plurality. The mere fact that certain measures are recited in mutually different claims does not indicate that a combination of these measures cannot be used to an advantage.

1. A transmission system, such as for a two wheeled bicycle, having an input and an output,
wherein the input is arranged to be connected to a crank and/or an electric motor and/or a user input,
wherein the output is arranged to be connected to a driven wheel,
wherein the system includes at least two parallel transmission paths from the input to the output, at least one of the transmission paths including at least one transmission, at least one of the transmission paths including at least one transmission clutch,
wherein at least one of the transmission paths includes at least one load-shifting clutch, the at least one load-shifting clutch being a form closed clutch arranged to transfer torque in at least one rotational direction.

2. The transmission system of claim 1, wherein the at least one load-shifting clutch is arranged for being decoupled under load.

3. The transmission system of claim 1 or 2, wherein a first transmission path includes a first load-shifting clutch that is arranged for being be decoupled under load, and wherein a second transmission path includes a second load-shifting clutch that is arranged for being be decoupled under load.

4. The transmission system of claim 1, 2 or 3, wherein the at least one load-shifting clutch has a clutch input, and a clutch output, the clutch including:
a first unit connectable to the clutch input or clutch output, including at least one first abutment surface;
a second unit connectable to the clutch output or clutch input,
respectively, including at least one second abutment surface arranged for selectively engaging the first abutment surface, the first and second abutment surfaces being adapted to each other so as to allow disengaging under load, preferably in two directions;
a third unit including at least one retaining member, the third unit being arranged for selectively being in a first mode or a second mode relative to the second unit, wherein the at least one retaining member in the first mode locks the at least one second abutment surface for rotationally coupling the second unit to the first unit, e.g. in two directions, and in the second mode releases the at least one second abutment surface for decoupling the second unit from the first unit.

5. The transmission system of any one of claims 1-4, wherein the at least one transmission clutch is embodied as a one-way bearing, one-way clutch, dog-clutch, spline-clutch.

6. The transmission system of any one of claims 1-5, wherein at least one of the transmission paths contains two or more transmissions.

7. The transmission system of any one of claims 1-6, wherein at least one of the transmission clutches is actuated with a mechanical, electrical and/or hydraulical actuator.

8. The transmission system of any one of claims 1-7, wherein at least one of the transmission paths includes at least two transmission elements with which two different transmission ratios can be made

9. The transmission system of claim 8, wherein at least one of the transmission clutches is arranged for preselecting of a transmission element by actuation of said at least one of the transmission clutches, such as through a transmission actuator.

10. The transmission system of claim 8, wherein the system is arranged for preselecting of a transmission element only in the transmission path via which no torque is transmitted at the moment of actuation.

11. The transmission system of any of claim 1-10, wherein the at least one transmission clutch and the at least one load-shifting clutch are arranged for being operated independently.

12. The transmission system of claim 11, wherein actuators for actuation of at least one transmission clutch and the at least one load-shifting clutch are arranged for being operated independently.

13. The transmission system of any of claims 1-12, wherein actuators for actuation of the at least one load-shifting clutch and the at least one transmission clutch are arranged for being operated electronically by an actuator controller.

14. The transmission system of claim 13, wherein the actuator controller is arranged for communicating with an electric motor controller in an electric bicycle and/or is physically integrated with an electric motor controller.

15. The transmission system of claim 13 or 14, wherein the controller is arranged for adjusting a torque of the electric motor just before, after and/or during a transmission ratio change.

16. The transmission system of claim 13, 14 or 15, wherein the controller is arranged to initiate a transmission ratio change based on a wheel-speed, a crank-speed, a crank-torque, a wheel-torque, and/or other available parameters.

17. The transmission system of any of claims 1-16, including an additional transmission element, such as a reduction, in one of the transmission paths, or between the crank or electric motor and the input, or between the wheel and the output of the transmission system.

18. A bicycle wheel axle assembly, comprising
the transmission system of any of claims 1-17;
a driver configured to be driven by a crank, such as via a chain drive, belt drive or cardan drive;
a wheel hub;
wherein the input of the transmission system is connected to the driver, and the output of the transmission system is connected to the wheel hub.

19. The bicycle wheel axle assembly of claim 18, wherein the transmission system is positioned inside the wheel hub and/or the driver.

20. The bicycle wheel axle assembly of claim 18 or 19, comprising an electric motor positioned inside the hub and/or the driver.

21. The bicycle wheel axle assembly of claim 20, wherein the driver is connected to an intermediate drive part, e.g. via a freewheel clutch, and the rotor of the electric motor is connected to the intermediate drive part, e.g. via a motor transmission.

22. The bicycle wheel axle assembly of claim 21, wherein the intermediate drive part is connected to drive the transmission system.

23. The bicycle wheel axle assembly of claim 20, wherein the electric motor is connected to drive the wheel hub.

24. The bicycle wheel axle assembly of any of claims 20-23, wherein the stator of the electric motor is connected to a wheel axle.

25. The bicycle wheel axle assembly of any of claims 21-24, wherein the driver is configured to transmit torque to the intermediate drive part on a diameter smaller than that of a smallest sprocket connected to the driver.

26. The bicycle wheel axle assembly of any of claims 20-25, wherein the sprocket(s) or cassette which are connected to the driver are supported directly via a bearing on the wheel hub.

27. The bicycle wheel axle assembly of any of claims 20-26, wherein the wheel hub is supported on the driver side of the wheel axle assembly via a bearing, which bearing is positioned axially further from a center of the wheel axle assembly than a middle sprocket.

28. A bicycle wheel including the transmission system of any one of claims 1-17 or a wheel axle assembly according to any of claims 18-27.

29. A bicycle including the transmission system of any one of claims 1-17, a wheel axle assembly according to any of claims 18-27, or a wheel according to claim 28.

30. The bicycle of claim 29, wherein the transmission system is located near the bicycle rear wheel and optionally the rear wheel shaft is integrated in the transmission system, or wherein the transmission system is located near the bicycle crank and optionally the crank shaft is integrated in the transmission system.

31. A clutch or brake system, such as for use in a transmission system according to any one of claims 1-17, having an input, and an output, the system including:
a first unit connectable to the input or output, including at least one first abutment surface;
a second unit connectable to the output or input, respectively, including at least one second abutment surface arranged for selectively engaging the first abutment surface, the first and second abutment surfaces being adapted to each other so as to allow disengaging under load;
a third unit including at least one retaining member, the third unit being arranged for selectively being in a first mode or a second mode relative to the second unit, wherein the at least one retaining member in the first mode locks the at least one second abutment surface for rotationally coupling the second unit to the first unit, and in the second mode releases the at least one second abutment surface for decoupling the second unit from the first unit.

32. The system of claim 31, wherein at least one of the first unit, the second unit, and the third unit is rotatable, optionally at least two of the first unit, the second unit, and the third unit are rotatable, optionally all of the first unit, the second unit, and the third unit are rotatable.

33. The system of claim 31 or 32, wherein the first unit or the second unit is non-rotatable, and optionally the third unit is non-rotatable.

34. The system of claim 31, 32 or 33, wherein:
a) the first unit is connectable to the input, the second unit is connectable to the output, the second unit is arranged at least partially coaxially inside the first unit, and the third unit is arranged at least partially coaxially inside the second unit;
b) the first unit is connectable to the output, the second unit is connectable to the input, the second unit is arranged at least partially coaxially inside the first unit, and the third unit is arranged at least partially coaxially inside the second unit;
c) the first unit is connectable to the output, the second unit is connectable to the input, the first unit is arranged at least partially coaxially inside the second unit, and the second unit is arranged at least partially coaxially inside the third unit;
d) the first unit is connectable to the input, the second unit is connectable to the output, the first unit is arranged at least partially coaxially inside the second unit, and the second unit is arranged at least partially coaxially inside the third unit;
e) the first unit is connectable to the input, the second unit is connectable to the output, the second unit is arranged at least partially axially beside the first unit, and the third unit is arranged at least partially axially beside the first unit or the second unit;
f) the first unit is connectable to the output, the second unit is connectable to the input, the second unit is arranged at least partially axially beside the first unit, and the third unit is arranged at least partially axially beside the first unit or the second unit;
g) the first unit is connectable to the input, the second unit is connectable to the output, the second unit is arranged at least partially coaxially inside the first unit, and the third unit is arranged at least partially axially beside the first and/or second unit;
h) the first unit is connectable to the output, the second unit is connectable to the input, the second unit is arranged at least partially coaxially inside the first unit, and the third unit is arranged at least partially axially beside the first and/or second unit;
i) the first unit is connectable to the input, the second unit is connectable to the output, the first unit is arranged at least partially coaxially inside the second unit, and the third unit is arranged at least partially axially beside the first and/or second unit;
j) the first unit is connectable to the output, the second unit is connectable to the input, the first unit is arranged at least partially coaxially inside the second unit, and the third unit is arranged at least partially axially beside the first and/or second unit;
k) the first unit is connectable to the input, the second unit is connectable to the output, the second unit is arranged at least partially axially beside the first unit, and the third unit is arranged at least partially coaxially inside the first and/or second unit;
l) the first unit is connectable to the input, the second unit is connectable to the output, the second unit is arranged at least partially axially beside the first unit, and the third unit is arranged at least partially coaxially inside the first and/or second unit;
m) the first unit is connectable to the input, the second unit is connectable to the output, the second unit is arranged at least partially axially beside the first unit, and the third unit is arranged at least partially coaxially around the first and/or second unit; or
n) the first unit is connectable to the input, the second unit is connectable to the output, the second unit is arranged at least partially axially beside the first unit, and the third unit is arranged at least partially coaxially around the first and/or second unit.

35. The system of any one of claims 31-34, including a fourth unit arranged for actuating, such as rotating, the third unit from the first mode to the second mode, and/or from the second mode to the first mode.

36. The system of claim 35, wherein the fourth unit is non-rotatable.

37. The system of claim 35 or 36, wherein:
a) the first unit is connectable to the input, the second unit is connectable to the output, the second unit is arranged at least partially coaxially inside the first unit, the third unit is arranged at least partially coaxially inside the second unit, and the fourth unit is arranged at least partially coaxially inside the third unit;
b) the first unit is connectable to the output, the second unit is connectable to the input, the second unit is arranged at least partially coaxially inside the first unit, the third unit is arranged at least partially coaxially inside the second unit, and the fourth unit is arranged at least partially coaxially inside the third unit;
c) the first unit is connectable to the output, the second unit is connectable to the input, the first unit is arranged at least partially coaxially inside the second unit, the second unit is arranged at least partially coaxially inside the third unit, and the third unit is arranged at least partially coaxially inside the fourth unit;
d) the first unit is connectable to the input, the second unit is connectable to the output, the first unit is arranged at least partially coaxially inside the second unit, the second unit is arranged at least partially coaxially inside the third unit, and the third unit is arranged at least partially coaxially inside the fourth unit;
e) the first unit is connectable to the input, the second unit is connectable to the output, the second unit is arranged at least partially axially beside the first unit, the third unit is arranged at least partially axially beside the first unit or the second unit, and the fourth unit is arranged at least partially axially beside the third unit;
f) the first unit is connectable to the output, the second unit is connectable to the input, the second unit is arranged at least partially axially beside the first unit, the third unit is arranged at least partially axially beside the first unit or the second unit, and the fourth unit is arranged at least partially axially beside the third unit;
g) the first unit is connectable to the input, the second unit is connectable to the output, the second unit is arranged at least partially coaxially inside the first unit, the third unit is arranged at least partially axially beside the first and/or second unit and the fourth unit is arranged at least partially axially beside the third unit;
h) the first unit is connectable to the output, the second unit is connectable to the input, the second unit is arranged at least partially coaxially inside the first unit, the third unit is arranged at least partially axially beside the first and/or second unit, and the fourth unit is arranged at least partially axially beside the third unit;
i) the first unit is connectable to the input, the second unit is connectable to the output, the second unit is arranged at least partially coaxially inside the first unit, the third unit is arranged at least partially axially beside the first and/or second unit and the fourth unit is arranged at least partially coaxially inside and/or outside the third unit;
j) the first unit is connectable to the output, the second unit is connectable to the input, the second unit is arranged at least partially coaxially inside the first unit, the third unit is arranged at least partially axially beside the first and/or second unit, and the fourth unit is arranged at least partially coaxially inside and/or outside the third unit;
k) the first unit is connectable to the input, the second unit is connectable to the output, the first unit is arranged at least partially coaxially inside the second unit, the third unit is arranged at least partially axially beside the first and/or second unit, and the fourth unit is arranged at least partially axially beside the third unit;
l) the first unit is connectable to the output, the second unit is connectable to the input, the first unit is arranged at least partially coaxially inside the second unit, the third unit is arranged at least partially axially beside the first and/or second unit, and the fourth unit is arranged at least partially axially beside the third unit;
m) the first unit is connectable to the input, the second unit is connectable to the output, the first unit is arranged at least partially coaxially inside the second unit, the third unit is arranged at least partially axially beside the first and/or second unit, and the fourth unit is arranged at least partially coaxially inside and/or outside the third unit;
n) the first unit is connectable to the output, the second unit is connectable to the input, the first unit is arranged at least partially coaxially inside the second unit, the third unit is arranged at least partially axially beside the first and/or second unit, and the fourth unit is arranged at least partially coaxially inside and/or outside the third unit;
o) the first unit is connectable to the input, the second unit is connectable to the output, the second unit is arranged at least partially axially beside the first unit, the third unit is arranged at least partially coaxially inside the first and/or second unit, and the fourth unit is arranged at least partially coaxially inside the third unit;
p) the first unit is connectable to the input, the second unit is connectable to the output, the second unit is arranged at least partially axially beside the first unit, the third unit is arranged at least partially coaxially inside the first and/or second unit, and the fourth unit is arranged at least partially coaxially inside the third unit;
q) the first unit is connectable to the input, the second unit is connectable to the output, the second unit is arranged at least partially axially beside the first unit, the third unit is arranged at least partially coaxially inside the first and/or second unit, and the fourth unit is arranged at least partially axially beside the third unit;
r) the first unit is connectable to the input, the second unit is connectable to the output, the second unit is arranged at least partially axially beside the first unit, the third unit is arranged at least partially coaxially inside the first and/or second unit, and the fourth unit is arranged at least partially axially beside the third unit;
s) the first unit is connectable to the input, the second unit is connectable to the output, the second unit is arranged at least partially axially beside the first unit, the third unit is arranged at least partially coaxially around the first and/or second unit, and the fourth unit is arranged at least partially coaxially around the third unit;
t) the first unit is connectable to the input, the second unit is connectable to the output, the second unit is arranged at least partially axially beside the first unit, the third unit is arranged at least partially coaxially around the first and/or second unit, and the fourth unit is arranged at least partially coaxially around the third unit;
u) the first unit is connectable to the input, the second unit is connectable to the output, the second unit is arranged at least partially axially beside the first unit, the third unit is arranged at least partially coaxially around the first and/or second unit, and the fourth unit is arranged at least partially axially beside the third unit; or
v) the first unit is connectable to the input, the second unit is connectable to the output, the second unit is arranged at least partially axially beside the first unit, the third unit is arranged at least partially coaxially around the first and/or second unit, and the fourth unit is arranged at least partially axially beside the third unit.

38. A method for operating a clutch or brake system for a torque transmission having an input, and an output, the method including:
providing a clutch or brake system including:
a first unit connectable to the input or the output, including at least one first abutment surface;
a second unit connectable to the output or the input, respectively, including at least one second abutment surface arranged for selectively engaging the first abutment surface, the first abutment surface and second abutment surface being adapted to each other so as to allow disengaging under load;
a third unit including at least one retaining member, the third unit being arranged for selectively being in a first mode or a second mode relative to the second unit, wherein the third unit in the first mode locks the at least one second abutment surface in engagement with the at least one first abutment surface for rotationally coupling the second unit to the first unit, and in the second mode releases the at least one second abutment surface for disengagement of the at least one first abutment surface for decoupling the second unit from the first unit; and
bringing the third unit relative to the second unit from a first mode to a second mode for disengaging the clutch or brake system, and bringing the third rotatable unit relative to the second rotatable unit from a mode position to a first mode for engaging the clutch or brake system.
